(19) United States
(12) Patent Application Publication
(10) Pub. No.: US 2024/0259907 A1
(43) Pub. Date: Aug. 1, 2024

(54) METHOD AND APPARATUS FOR TRIGGERING GENERATION OF BACKHAUL RADIO LINK FAILURE NOTIFICATION

(71) Applicant: FUJITSU LIMITED, Kawasaki-shi Kanagawa (JP)

(72) Inventors: Meiyi JIA, Beijing (CN); Su YI, Beijing (CN); Guorong LI, Beijing (CN)

(73) Assignee: FUJITSU LIMITED, Kawasaki-shi Kanagawa (JP)

(21) Appl. No.: 18/430,127

(22) Filed: Feb. 1, 2024

Related U.S. Application Data
(63) Continuation of application No. PCT/CN2021/110408, filed on Aug. 3, 2021.

(51) Int. Cl. H04W 36/30; H04W 36/00

(52) U.S. Cl. CPC H04W 36/305; H04W 36/0019; H04W 36/0069; H04W 36/00837

(57) ABSTRACT

Embodiments of this disclosure provide a method and apparatus for triggering to generate a backhaul link radio link failure notification. The method is applicable to a first node and includes: when a radio link failure is detected and when a first condition is satisfied and/or based on a state of a timer, triggering or not triggering to generate a backhaul link radio link failure notification; or, triggering or not triggering to generate a backhaul link radio link failure notification based on a state of a timer; or, when a first condition is satisfied, triggering or not triggering to generate a backhaul link radio link failure notification based on a state of a timer.

### CROSS-REFERENCE TO RELATED APPLICATION

This application is a continuation of International Application No. PCT/CN2021/110408, filed on Aug. 3, 2021, the entire contents of which are incorporated herein by reference.

### TECHNICAL FIELD

This disclosure relates to the field of communication technologies.

### BACKGROUND

Integrated access and backhaul (IAB) ensures wireless relay in NG-RAN. A relay node, namely, an IAB-node, supports NR access and backhauling. The backhauling may include a single hop or multiple hops. An end point of network side NR backhauling, namely, an IAB-donor, refers to a gNB that supports additional functions of the IAB. The IAB-donor may also be referred to as an IAB-donor-node.

The IAB-node supports functions of a gNB-DU (distributed unit), i.e. an IAB-DU. The IAB-DU terminates an NR access interface to a terminal equipment and a next hop of IAB-node, and terminates an F1 protocol of a gNB-CU function on the IAB-donor. In addition, the IAB-node also supports a subset of terminal equipment functions (UE functions), namely, IAB-MT, which includes, for example, functions of a gNB-DU connected to another IAB-node or the IAB-donor, a gNB-CU (centralized unit) connected to the IAB-donor and a physical layer, layer 2 (L2), RRC (radio resource control) and NAS (non-access stratum) connected to a core network.

The IAB-node is connected to an IAB-donor via one or more hops. In topology, the IAB-donor is a root node, a neighboring node on the IAB-DU interface of the IAB-node is referred to as a descendant IAB-node, i.e. a descendant IAB-node, and a neighboring node on an IAB-MT interface is referred to as a parent node, i.e. a parent IAB-node.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In a case where a radio link failure (RLF) occurs in a backhaul link (BH link) between an IAB-node and its parent IAB-node, it may involve triggering, generation or transmission of a notification or indication of a backhaul link radio link failure (BH RLF).

The notification or indication of the backhaul link radio link failure (BH RLF) includes the following:

The notification or indication of the BH link RLF includes the following four types:
type-1: “Plain” notification, i.e. an indication that a descendant IAB-node detects a backhaul link radio link failure;
type-2: recovery attempt, i.e. an indication that a descendant IAB-node detects a backhaul link radio link failure and is in an attempt to recover from the failure;
type-3: a backhaul link radio link failure is recovered, i.e. an indication that the backhaul link is successfully recovered from the radio link failure; and
type-4/4X: a recovery failure/indicating that a descendant IAB-node performs a radio link failure procedure, i.e. an indication of a recovery failure of a backhaul link radio link failure;
wherein that when a parent IAB-node transmit this indication is based on implementation, and when it receives this indication, the descendant IAB-node should perform a procedure related to a radio link failure;
according to the current mechanism, when an RRC reestablishment procedure fails, the IAB-node may transmit a backhaul link radio link failure (BH RLF) notification or indication to its descendant nodes; for example, the BH RLF notification or indication here refers to the above type-4/4X backhaul link radio link failure notification or indication;
in addition, when a radio link failure is detected, a type-2 RLF indication is triggered. For example, the type-2 RLF notification or indication here refers to the above type-1 or type-2 backhaul link radio link failure notification or indication.

In NR, when one of the following conditions is satisfied, the terminal equipment or IAB-MT deems that a radio link failure is detected:
1) timer T310/T312 expires in a special cell;
2) an indication of random access issue from MAC, while T300/T301/T304/T311/T319 is/are not in operation;
3) an indication from RLC that a maximum number of times of retransmission is reached;
4) if connected as an IAB-node, a BAP entity receives a BH RLF indication;
5) a continuous uplink LBT failure indication from MAC, while T304 is not in operation.

When the terminal equipment or IAB-MT is not configured with dual connectivity (DC) or when the terminal equipment or IAB-MT is configured with DC and the above conditions occur in a master cell group (MCG) or primary cell (PCell), the terminal equipment or IAB-MT deems that the MCG has detected an RLF; and if the terminal equipment or IAB-MT is configured with DC and the above conditions occur in the (secondary cell group) SCG or PSCell, the terminal equipment or IAB-MT deems that the SCG has detected an RLF.

If dual activity protocol stack handover (DAPS HO) is in progress and conditions 1)-5) occur in a target PCell, the terminal equipment or IAB-MT deems that the target MCG has detected an

RLF; and when T310 in a source special cell expires or when an indication of random access issue is from a source MCG MAC or when an indication that a maximum number of times of retransmission has been reached is from a source MCG RLC or when an indication of a consistent uplink LBT failure is from the source MCG MAC, the terminal equipment or IAB-MT deems that the source MCG has detected an RLF, i.e. a source RLF.

In addition, when an RLF is detected, a type-2 RLF indication is triggered. And when the above RLF, including an MCG RLF, an SCG RLF, a source RLF and a target RLF, is detected, generation of a type-2 radio link failure notification or indication is triggered.

It was found by the inventors that according to the current mechanism, generation of a type-2 radio link failure notification or indication will be triggered in many cases, which may possibly cause type-2 radio link failure notification or indication storms.

On the one hand, transmission of a type-2 radio link failure notification or indication occupies resources of a backhaul link, and a type-2 radio link failure notification or indications storm will consume a large amount of backhaul link resources, resulting in resource shortage of data transmission; and on the other hand, the type-2 radio link failure notification or indication may be transmitted via a BAP control PDU, which is generated by an IAB-node with no security protection and may pose security problems, and the type-2 radio link failure notification or indication storm increases a likelihood of occurrence of security issues.

In order to solve one or more of the above problems, embodiments of this disclosure provide a method and apparatus for triggering to generate a backhaul link radio link failure notification, in which triggering to generate a backhaul link radio link failure notification is limited, thereby avoiding RLF indication storms, lowering resource overhead and reducing security risks.

According to a first aspect of the embodiments of this disclosure, there is provided an apparatus for triggering to generate a backhaul link radio link failure notification, applicable to a first node, the apparatus including: when a radio link failure is detected and when a first condition is satisfied and/or based on a state of a timer, triggering or not to triggering to generate a backhaul link radio link failure notification; or, triggering or not to triggering to generate a backhaul link radio link failure notification based on a state of a timer; or, when a first condition is satisfied, triggering or not to triggering to generate a backhaul link radio link failure notification based on a state of a timer.

According to a second aspect of the embodiments of this disclosure, there is provided an apparatus for triggering to generate a backhaul link radio link failure notification, applicable to a first node, the apparatus including: when a second condition is satisfied, triggering to generate a backhaul link radio link failure notification; or, when a second condition is satisfied, based on a state of a timer, triggering or not triggering to generate a backhaul link radio link failure notification, the second condition including at least one of the following that: a first timer expires; a second timer expires; RRC connection reconfiguration fails; and an integrity check failure indication from a lower layer is received.

According to a third aspect of the embodiments of this disclosure, there is provided a network device, the network device being a first node and including the apparatus as described in the embodiment of the first or second aspect of this disclosure.

According to a fourth aspect of the embodiments of this disclosure, there is provided a communication system, including the network device as described in the embodiment of the third aspect of this disclosure.

According to a fifth aspect of the embodiments of this disclosure, there is provided a method for triggering to generate a backhaul link radio link failure notification, applicable to a first node, the method including: when a radio link failure is detected and when a first condition is satisfied and/or based on a state of a timer, triggering or not to triggering to generate a backhaul link radio link failure notification; or, triggering or not to triggering to generate a backhaul link radio link failure notification based on a state of a timer; or, when a first condition is satisfied, triggering or not to triggering to generate a backhaul link radio link failure notification based on a state of a timer.

According to a sixth aspect of the embodiments of this disclosure, there is provided a method for triggering to generate a backhaul link radio link failure notification, applicable to a first node, the method including: when a second condition is satisfied, triggering to generate a backhaul link radio link failure notification; or, when a second condition is satisfied, based on a state of a timer, triggering or not triggering to generate a backhaul link radio link failure notification, the second condition including at least one of the following that: a first timer expires; a second timer expires; RRC connection reconfiguration fails; and an integrity check failure indication from a lower layer is received.

According to a seventh aspect of the embodiments of this disclosure, there is provided a computer readable program, which, when executed in an apparatus for triggering to generate a backhaul link radio link failure notification or a network device, will cause the apparatus for triggering to generate a backhaul link radio link failure notification or the network device to carry out the method for triggering to generate a backhaul link radio link failure notification as described in the embodiment of the fifth or sixth aspect of this disclosure.

According to an eighth aspect of the embodiments of this disclosure, there is provided a computer readable medium, including a computer readable program code, which will cause an apparatus for triggering to generate a backhaul link radio link failure notification or a network device to carry out the method for triggering to generate a backhaul link radio link failure notification as described in the embodiment of the fifth or sixth aspect of this disclosure.

An advantage of the embodiments of this disclosure exists in that when a radio link failure is detected and when a first condition is satisfied and/or based on a state of a timer, generation of a backhaul link radio link failure notification is triggered or not triggered; or, generation of a backhaul link radio link failure notification is triggered or not triggered based on a state of a timer; or, when a first condition is satisfied, generation of a backhaul link radio link failure notification is triggered or not triggered based on a state of a timer. Hence, by limiting triggering to generate a backhaul link radio link failure notification, RLF indication storms may be avoided, resource overhead may be lowered and security risks may be reduced.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of an overall architecture of IAB of an embodiment of this disclosure;

FIG. 2 is another schematic diagram of the overall architecture of the IAB of the embodiment of this disclosure;

FIG. 3 is a schematic diagram of a protocol stack of an F1-U interface between an IAB-DU and an IAB-donor-CU;

FIG. 4 is a schematic diagram of a protocol stack of an F1-C interface between an IAB-DU and an IAB-donor-CU;

FIG. 5 is a schematic diagram of a protocol stack of an SRB between an IAB-MT and an IAB-donor-CU of the embodiment of this disclosure;

FIG. 6 is a schematic diagram of a single connectivity scenario of an SA mode of the embodiment of this disclosure;

FIG. 7 is a schematic diagram of a dual connectivity scenario of an EN-DC mode of the embodiment of this disclosure;

FIG. 8 is a schematic diagram of a dual connectivity scenario of an NR-DC mode of the embodiment of this disclosure;

FIG. 9 is a schematic diagram of the method for triggering to generate a backhaul link radio link failure notification of embodiment 1 of this disclosure;

FIG. 10 is another schematic diagram of the method for triggering to generate a backhaul link radio link failure notification of embodiment 1 of this disclosure;

FIG. 11 is a further schematic diagram of the method for triggering to generate a backhaul link radio link failure notification of embodiment 1 of this disclosure;

FIG. 12 is still another schematic diagram of the method for triggering to generate a backhaul link radio link failure notification of embodiment 1 of this disclosure;

FIG. 13 is a schematic diagram of the method for triggering to generate a backhaul link radio link failure notification of embodiment 2 of this disclosure;

FIG. 14 is a schematic diagram of the method for triggering to generate a backhaul link radio link failure notification of embodiment 3 of this disclosure;

FIG. 15 is a schematic diagram of the method for triggering to generate a backhaul link radio link failure notification of embodiment 3 of this disclosure;

FIG. 16 is a schematic diagram of the method for triggering to generate a backhaul link radio link failure notification of embodiment 3 of this disclosure;

FIG. 17 is a schematic diagram of the method for triggering to generate a backhaul link radio link failure notification of embodiment 3 of this disclosure;

FIG. 18 is a schematic diagram of the method for triggering to generate a backhaul link radio link failure notification of embodiment 3 of this disclosure;

FIG. 19 is a schematic diagram of the apparatus for triggering to generate a backhaul link radio link failure notification of embodiment 4 of this disclosure;

FIG. 20 is a schematic diagram of the first triggering unit of embodiment 4 of this disclosure;

FIG. 21 is a schematic diagram of the second triggering unit of embodiment 4 of this disclosure;

FIG. 22 is a schematic diagram of the apparatus for triggering to generate a backhaul link radio link failure notification of embodiment 5 of this disclosure;

FIG. 23 is a block diagram of a systematic structure of the network device of embodiment 6 of this disclosure;

FIG. 24 is a block diagram of a systematic structure of the network device of embodiment 7 of this disclosure;

FIG. 25 is a schematic diagram of the communication system of embodiment 8 of this disclosure;

FIG. 26 is another schematic diagram of the communication system of embodiment 8 of this disclosure; and

FIG. 27 is a further schematic diagram of the communication system of embodiment 8 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc., such as a terminal equipment served by an IAB-node or an IAB-donor-node under an IAB architecture.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, all of “when . . . ”, “in a case where . . . ”, “for a case where . . . ” and “if . . . ” denote one or some conditions or states, and furthermore, all of these expressions are interchangeable.

Scenarios of the embodiments of this disclosure shall be described below by way of examples; however, this disclosure is not limited thereto.

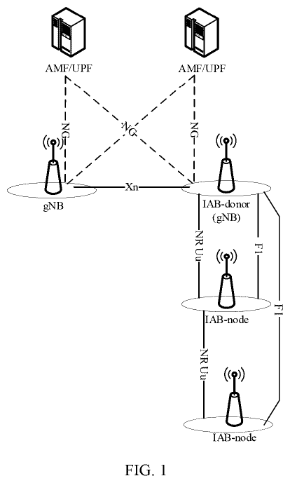

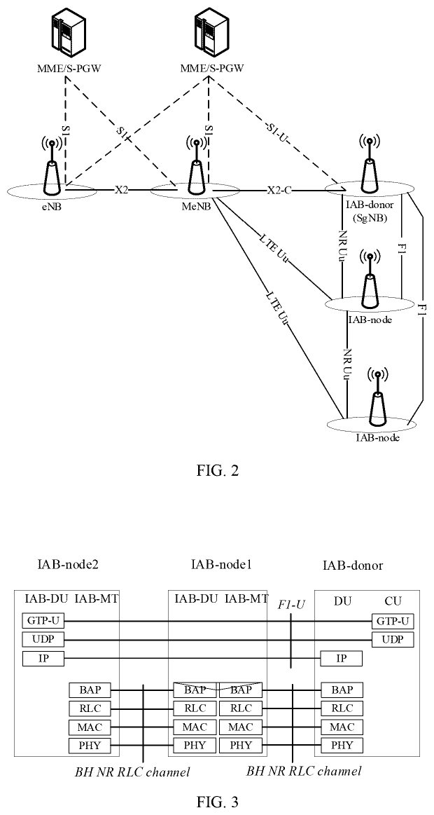

FIG. 1 is a schematic diagram of an overall architecture of an IAB in an embodiment of this disclosure. As shown in FIG. 1, the overall architecture of the IAB is in a standalone (SA) mode. FIG. 2 is another schematic diagram of the overall architecture of the IAB of the embodiment of this disclosure. As shown in FIG. 2, the overall architecture of the IAB is in a dual-connectivity (EN-DC) mode. In the dual-connectivity mode, the IAB-node is connected to an MeNB via E-UTRA, and an IAB-donor terminates X2-C as an SgNB.

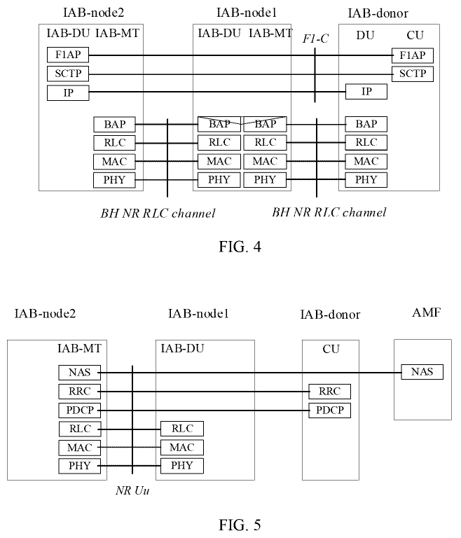

FIG. 3 is a schematic diagram of a protocol stack of an F1-U interface between an IAB-DU and an IAB-donor-CU, and FIG. 4 is a schematic diagram of a protocol stack of an F1-C interface between an IAB-DU and an IAB-donor-CU. In FIG. 3 and FIG. 4, F1-U and F1-C are illustrated by taking 2-hop backhaul as an example.

In the embodiment of this disclosure, F1-U and F1-C use an IP transmission layer between the IAB-DU and IAB-donor-CU. In addition, F1-U and F1-C have security protection.

In the embodiment of this disclosure, the IP layer transmits via a backhaul adaptation protocol (BAP) sublayer on wireless backhaul to ensure multi-hop routing; and the IP layer may also be used for non-F1 services, such as operation administration and maintenance (OAM) services.

In the embodiment of this disclosure, BAP PDUs are transmitted via BH RLC channels on each backhaul link, and on each BH link, multiple BH RLC channels may be configured to allow traffic prioritization and QoS (quality of service) enforcement.

In the embodiment of this disclosure, each IAB-node and a BAP entity on the IAB-donor-DU perform mapping of the BH RLC channels of the BAP PDUs.

In the embodiment of this disclosure, the IAB-MT and IAB-donor-CU establish SRBs for carrying RRC and NAS. FIG. 5 is a schematic diagram of a protocol stack of the SRBs between the IAB-MT and the IAB-donor-CU of the embodiment of this disclosure.

In the embodiment of this disclosure, for the IAB-node operating in the EN-DC mode, the IAB-MT also establishes one or more DRBs with the IAB-donor-CU, which may be used to transmit OAM services, for example. For the SA mode, establishment of DRBs is optional. These SRBs and DRBs are transmitted between the IAB-MT and its parent node via a Uu interface channel.

Application scenarios of the embodiment of this disclosure shall be illustrated below.

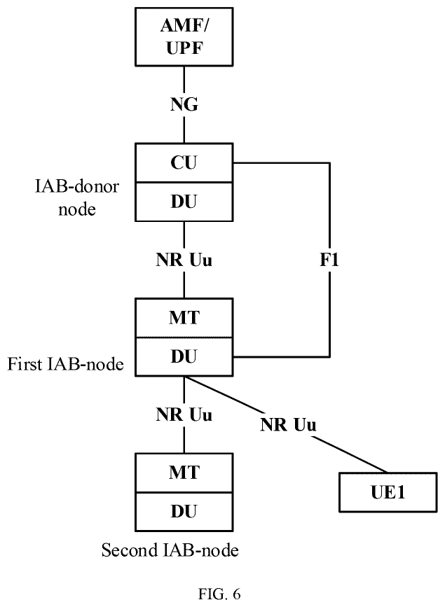

FIG. 6 is a schematic diagram of a single connectivity scenario of an SA mode of the embodiment of this disclosure. As shown in FIG. 6, in the SA mode, a first IAB-node is connected to an IAB-donor-node in a single connectivity manner, and the first IAB-node detects a radio link failure in a backhaul link between it and the parent IAB-node, i.e. the IAB-donor-node.

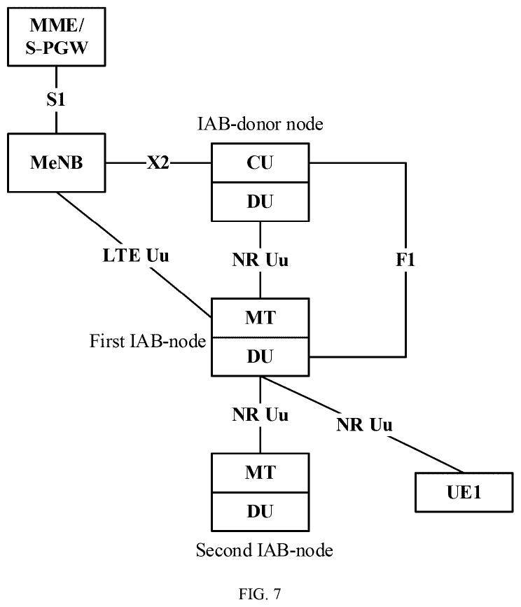

FIG. 7 is a schematic diagram of a dual connectivity scenario of the EN-DC mode of the embodiment of this disclosure. As shown in FIG. 7, in the EN-DC mode, the first IAB-node may be accessed to a network via the IAB-donor-node and an MeNB. In addition, in the EN-DC, backhauling services on an E-UTRA wireless interface are not supported.

For example, the first IAB-node detects an MCG RLF between it and the MeNB.

And for another example, the first IAB-node detects an SCG RLF between it and the IAB-donor-node.

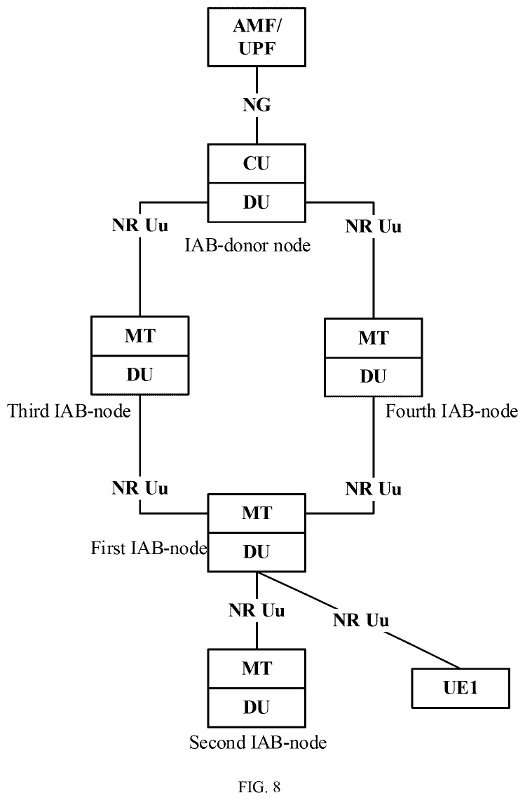

FIG. 8 is a schematic diagram of a dual connectivity scenario of the NR-DC mode of the embodiment of this disclosure. As shown in FIG. 8, in the NR-DC mode, the first IAB-node may be accessed to the network via two parent IAB-nodes, i.e. a third IAB-node and a fourth IAB-node, the third IAB-node being a master node, and the fourth IAB-node being a secondary node.

For example, the first IAB-node detects an MCG RLF between it and the third IAB-node.

For another example, the first IAB-node detects an SCG RLF between it and the fourth IAB-node.

Various implementations of the embodiments of this disclosure shall be described below with reference to the accompanying drawings. These implementations are illustrative only, and are not intended to limit this disclosure.

### Embodiment 1

The embodiment of this disclosure provides a method for triggering to generate a backhaul link radio link failure notification, applicable to a first node.

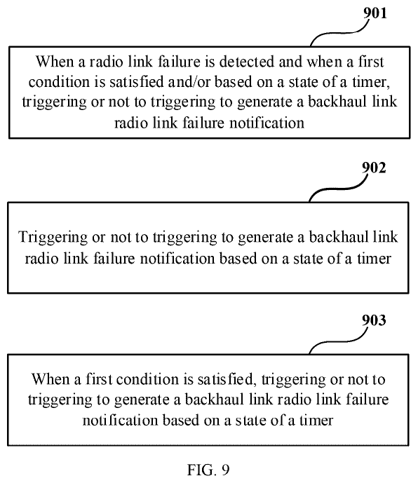

FIG. 9 is a schematic diagram of the method for triggering to generate a backhaul link radio link failure notification of embodiment 1 of this disclosure. As shown in FIG. 9, the method includes:
step 901: when a radio link failure is detected and when a first condition is satisfied and/or based on a state of a timer, triggering or not to triggering to generate a backhaul link radio link failure notification; or,
step 902: triggering or not to triggering to generate a backhaul link radio link failure notification based on a state of a timer; or,
step 903: when a first condition is satisfied, triggering or not to triggering to generate a backhaul link radio link failure notification based on a state of a timer.

Hence, by limiting triggering to generate a backhaul link radio link failure notification, RLF indication storms may be avoided, resource overhead may be lowered and security risks may be reduced.

In the embodiment of this disclosure, the radio link failure may be a radio link failure of a backhaul link.

For example, a backhaul link refers to a backhaul link between an IAB-node and its parent IAB-node.

For example, the radio link failure of the backhaul link may be triggered for a variety of reasons, such as that timer T310 in a master cell of the IAB-node or IAB-MT, or the IAB-node or IAB-MT receives a random access issue indication from its MAC while timer T300/T301/T304/T311/T319 are not in operation, or the IAB-node or IAB-MT receives indication that a maximum number of times of retransmission has been reached from its RLC, or, the IAB-node or IAB-MT receives a type-4 BH RLF indication from its parent IAB-node, or the IAB-node or IAB-MT receives a continuous uplink LBT failure indication from its MAC, etc.

For example, a type-4 BH RLF indication, i.e. a type-4/4X BH link RLF notification or indication, is used to notify/indicate a recovery failure/indicate a procedure of performing radio link failure by a descendant node. When an RRC reestablishment procedure of the parent IAB-node fails, a type-4 BH RLF indication may be transmitted to the IAB-node.

In the embodiment of this disclosure, the first node is connected as an IAB-node, or, the first node is an IAB-node.

For example, that the first node is connected as an IAB-node, or, the first node is an IAB-node, includes at least one of the following that:
in a connection establishment procedure, the first node is accessed to the network as an IAB-node;
in a procedure of adding and/or updating a secondary node, the first node is connected to the secondary node as an IAB-node;
the first node serves for a descendant node or a terminal equipment as an IAB-node;
at least one connected IAB-node serves as a descendant node of the first node; and
at least one connected IAB-node has established a backhaul link RLC channel with the first node.

In the embodiment of this disclosure, for the case where the first node is accessed to the network as an IAB-node in the connection establishment procedure,
for example, a field is included in an RRCSetupComplete message, the field being used to indicate that the connection is established by the IAB-node, for example, the field is iab-NodeIndication-r16;
for example, the connection establishment procedure is part of an IAB-MT establishment phase or an establishment phase of an integration procedure of the node.

In the embodiment of this disclosure, for the case where the first node is connected to the secondary node as an IAB-node in the procedure of adding and/or updating the secondary node,
for example, the procedure of adding a secondary node may be in an SgNB addition phase of an IAB integration procedure operating in an NSA mode;
for example, an IE is included in an SGNB ADDION REQUEST message or an SGNB MODIFICATION REQUEST message, the IE being used to indicate that the request is from the IAB-node, for example, the IE is an IAB-node Indication.

In the embodiment of this disclosure, for the case where the first node serves for a descendant node or a terminal equipment as an IAB-node, for example, broadcasting supports IAB, that is, an IE or a domain is included in a system message, the IE or domain being used to indicate support of IAB and/or a cell state of IAB, for example,
the IE or domain is included in NPN-IdentityInfo or PLMN-IdentityInfo;
and the domain may be iab-support: when the domain is present, a cell of the node supports IAB and the cell may also be deemed as a candidate for IAB-node cell selection or reselection; and when the domain is absent, the cell of the node does not support IAB and/or the cell is barred for the IAB-node;
for example, the system message may be SIB1.

In the embodiment of this disclosure, the backhaul link radio link failure notification may also be referred to as a backhaul link radio link failure indication or a radio link failure notification or a radio link failure indication, and is used to indicate a radio link failure occurred between itself and the parent node to its descendant node, i.e. a radio link failure on the backhaul link.

In the embodiment of this disclosure, the backhaul link radio link failure notification may be a type-2 or type-1 radio link failure notification.

For example, the type-2 radio link failure notification is used to indicate that the first node detects a backhaul link radio link failure and the first node is attempting to recover from the backhaul link radio link failure, and the type-1 radio link failure notification is used to indicate that the first node detects a backhaul link radio link failure.

For example, the type-2 or type-1 radio link failure notification is carried by a BAP control PDU.

Contents of the first condition of the embodiment of this disclosure shall be explained below.

In the embodiment of this disclosure, the first condition may include that AS security has been activated and SRB2 has been established.

That AS security has been activated refers to that an initial security activation procedure between the first node and its master node or master IAB-donor is successfully completed. For example, in FIG. 6, an initial security activation procedure has been successfully completed between the first IAB-node and the IAB-donor; in FIG. 7, an initial security activation procedure has been successfully completed between the first IAB-node and MeNB; for another example, in FIG. 8, an initial security activation procedure has been successfully completed between the first IAB-node and the IAB-donor.

In the embodiment of this disclosure of this disclosure, the first condition further includes at least one of the following that:
1) in a case where the first node is configured with and/or uses dual connectivity and the radio link failure is an SCG radio link failure, an SCG failure information procedure is not initiated or is unable to be initiated;
2) in a case where the first node is configured with and/or uses dual connectivity and the radio link failure is an MCG radio link failure, a MCG failure information procedure is not initiated or is unable to be initiated; and
3) the first node is performing handover or migration.

In the embodiment of this disclosure, for 1), that an SCG failure information procedure is not initiated or is unable to be initiated includes at least one of the following that:
the SCG failure information is unable to be reported to an IAB-donor of the first node via an F1 interface message;
the dual connectivity is NR-DC; and
MCG transmission is suspended, or an MCG failure information procedure is initiated.

For example, that MCG transmission is suspended, or an MCG failure information procedure is initiated, includes:
when an MCG or SCG is not suspended and t316 is configured, in a case where an MCG RLF is detected and T316 of the node configured with split SRB1 or SRB3 is not in operation, or the MCG or the SCG is not suspended, an MCG RLF is detected while reporting MCG failure information to the IAB-donor via an F1 interface message is supported.

In the embodiment of this disclosure, for 2), that an MCG failure information procedure is not initiated or is unable to be initiated includes at least one of the following that:
the MCG failure information is unable to be reported to an IAB-donor of the first node via an F1 interface message;
a first timer is not configured; for example, the first timer is timer T316;
SCG transmission is suspended; and
PSCell change or PSCell increase is being performed.

For example, that timer T316 is not configured includes that this node is not configured with split SRB1 or SRB3, or, this node is configured with split SRB1 and/or SRB3, but the network does not indicate a value of timer T316, that is, domain T316 is not included.

For example, that SCG transmission is suspended includes that,

SCG failure information transmission is initiated, wherein when MCG transmission or SCG transmission is not suspended, an SCG RLF is detected, or reconfiguration with sync of the SCG fails, or SCG configuration fails, or an SCG lower layer indicates that SRB3-related integrity check fails, or,

EUTRA SCG failure message transmission is initiated, wherein an SCG RLF is detected when MCG transmission or SCG transmission is not suspended, or SCG change fails, or uplink transmission to the PSCell is stopped due to exceeding a maximum uplink transmission timing difference when powerControlMode is configured as 1.

For example, that PSCell change or PSCell increase is being performed includes: for the case where the dual connectivity is NR-DC, the timer T304 of the NR PSCell is in operation;
for example, when an RRCReconfiguration message including reconfigurationWithSync or conditional reconfiguration execution is received, i.e. when stored RRCReconfiguration message including reconfigurationWithSync is applied, timer T304 is started, and/or when random access or SCG release on a corresponding special cell is successfully completed, timer T304 is stopped.

For the case where the dual connectivity is NE-DC, the timer T307 of the E-UTRA PSCell is in operation;
for example, timer T304 is started when an RRCConnectionReconfiguration message including MobilityControlInfoSCG is received; and/or, when the random access on the PSCell is successfully completed and reestablishment or SCG release is initiated, timer T304 is stopped.

In the embodiment of this disclosure, for 3), that the first node is performing handover or migration includes that:
in a case where a second timer is running, when two protocol stacks are used to connect with a source parent node and a target parent node respectively, the two protocol stacks (dual protocol stacks) belong to one MT logical entity of the first node, or, the two protocol stacks (dual protocol stacks) respectively belong to two MT logical entities of the first node.

In the embodiment of this disclosure, the second timer is timer T304.

Similar to DAPS, the one MT logical entity of the first node includes two protocol stacks, that is, there exist two separate sets of PHY, MAC and RLC, and a common or separate BAP is used.

In the embodiment of this disclosure, the two protocol stacks (dual protocol stacks) may correspond to a backhaul link RLC channel.

For example, that the two protocol stacks are used to connect with a source parent node and a target parent node respectively indicates that any dual protocol stack backhaul link RLC channel is configured; for example, a first domain in IE BH-RLC-ChannelConfig is used to indicate that a BH RLC channel between the first node and its parent node is configured as a dual protocol stack BH RLC channel, the first domain being, for example, a domain similar to daps-Config-r16.

For example, the first domain in IE BH-RLC ChannelConfig is used to indicate that an identity of a channel between the first node and its parent node is a first index and/or a BH RLC channel of the identity is configured as a dual protocol stack BH RLC channel. For example, the first index may be bh-LogicalChannelIdentity-r16 or bh-RLC-ChannelID-r16.

For example, a BH RLC channel with a BH RLC channel ID of the first index is configured as a dual stack BH RLC channel; for example, a BH RLC channel with an index=x is configured as a dual stack BH RLC channel.

For another example, a BH RLC channel is implicitly specified as a dual stack BH RLC channel, that is, that the first index of the BH RLC channel is a dual stack BH RLC channel is not explicitly indicated. For example, configuration information of the dual stack BH RLC channel is included in configuration of a BH RLC channel, thereby implicitly specifying that this BH RLC channel is a dual stack BH RLC channel.

In the embodiment of this disclosure, the two protocol stacks (dual protocol stacks) may correspond to RRC bearers.

For example, that the two protocol stacks are respectively connected to the source parent node and the target parent node indicates that any dual protocol stack bearer is configured.

For example, a second domain in IE DRB-ToAddMod is used to indicate that a bearer is configured as a dual stack bearer. For example, the second domain is a domain daps-Config-r16.

For example, the second domain in IE DRB-ToAddMod is used to indicate that a bearer with a bearer identity of a second index and/or identity is configured as a dual protocol stack bearer. For example, the second index is drb-Identity.

For example, a bear with a bear ID of the second index is configured as a dual protocol stack bear; for example, a bear with a bear ID=y is configured as a dual protocol stack bear.

For another example, a bearer is implicitly specified as a dual protocol stack, that is, a bearer with the second index is not explicitly indicated as a dual protocol stack bearer. For example, configuration information of the dual protocol stack bearer is included in configuration of a bearer, thereby implicitly specifying that this bearer is a dual protocol stack bearer.

In the embodiment of this disclosure, when the radio link failure is a source radio link failure, generation of the backhaul link radio link failure notification is not triggered.

Or, when the radio link failure is a source radio link failure, generation of the backhaul link radio link failure notification is triggered, for example,
when no radio link failure is detected in the source PCell and the second timer of the MCG expires, generation of a type-3 radio link failure notification is triggered in a protocol stack connected to the source parent node, that is, in the source; and/or,
when a radio link failure is successfully recovered or when the handover or migration of the first node is completed successfully, generation of a type-3 radio link failure notification is triggered in a protocol stack connected to a target parent node, that is, in a target.

In the embodiment of this disclosure, the type-3 radio link failure notification indicates that the backhaul link has successfully recovered from the radio link failure, and the type-3 radio link failure notification is carried by the BAP control PDU.

For example, that the handover or migration of the first node is completed successfully includes at least one of the following:
the first node is synchronized to a target cell;
the first node successfully completes random access in the target cell;
the first node transmits an RRCReconfigurationComplete message;
the first node receives an explicit indication of L1 or L2, the indication being used to indicate that a source cell portion operated by the dual protocol stack is to be stopped and/or a source cell portion configured by the dual protocol stack is to be released; and
the first node has already released the source cell, as explicitly requested by the target node, such as the target parent IAB-node.

In the embodiment of this disclosure, when the radio link failure is a target radio link failure, for example,
when the target radio link failure is detected and the first condition is satisfied and/or based on the timer state, the generation of the backhaul link radio link failure notification is triggered or not triggered; or,
based on the state of the timer, the generation of the backhaul link radio link failure notification is triggered or not triggered; or,
when the first condition is satisfied, based on the state of the timer, the generation of the backhaul link radio link failure notification is triggered or not triggered.

That is, when a target radio link failure is detected, there are no further conditions, and the generation of the backhaul link radio link failure notification is triggered or not triggered in the method shown in FIG. 9; or, when a target radio link failure is detected, contents of the first condition apply when the first node is configured and/or uses dual connectivity and the radio link failure is an MCG radio link failure.

In the embodiment of this disclosure, in the case where the two protocol stacks belong respectively to two MT logical entities of the first node, the generation of the backhaul link radio link failure notification is triggered or not triggered according to the radio link failure of the source parent node or the radio link failure of the target parent node, which are respectively consistent with triggering during a non-handover period of a single protocol stack.

For example, 1) if the detected radio link failure is a radio link failure in the first node and a source of the source parent node, i.e. an RLF in source or a source RLF, when the radio link failure in the source is detected and the first condition is satisfied and/or based on the state of the timer, a backhaul link radio link failure notification in the source is triggered or not triggered; or, based on the state of the timer, a backhaul link radio link failure notification in the source is triggered or not triggered; or, when the first condition is satisfied, a backhaul link radio link failure notification in the source is triggered or not triggered based on the state of the timer; and/or, 2) when a second condition is satisfied, a backhaul link radio link failure notification in the source is triggered or not triggered, or, when a second condition is satisfied, a backhaul link radio link failure notification in the source is triggered or not triggered based on the state of the timer, the second condition including at least one of the following that: the first timer expires; the second timer expires; RRC connection reconfiguration fails; and an integrity check failure indication from a lower layer is received.

For another example, 1) if the detected radio link failure is a radio link failure in the first node and a source of the target parent node, i.e. an RLF in target or a target RLF, when the radio link failure in the target is detected and the first condition is satisfied and/or based on the state of the timer, a backhaul link radio link failure notification in the target is triggered or not triggered; or, based on the state of the timer, a backhaul link radio link failure notification in the target is triggered or not triggered; or, when the first condition is satisfied, a backhaul link radio link failure notification in the target is triggered or not triggered based on the state of the timer; and/or, 2) when a second condition is satisfied, a backhaul link radio link failure notification in the target is triggered or not triggered, or, when a second condition is satisfied, a backhaul link radio link failure notification in the target is triggered or not triggered based on the state of the timer, the second condition including at least one of the following that: the first timer expires; the second timer expires; RRC connection reconfiguration fails; and an integrity check failure indication from a lower layer is received.

The source parent node and target parent node may be IAB-nodes, or may be IAB-donors.

Reference may be made to what is described above for specific contents, and identical contents shall not be repeated any further.

The first condition in the embodiment of this disclosure is described above in detail.

In step 901, when a radio link failure is detected and the first condition is satisfied and/or based on the state of the timer, the generation of a backhaul radio link failure notification is triggered or not triggered. For example,

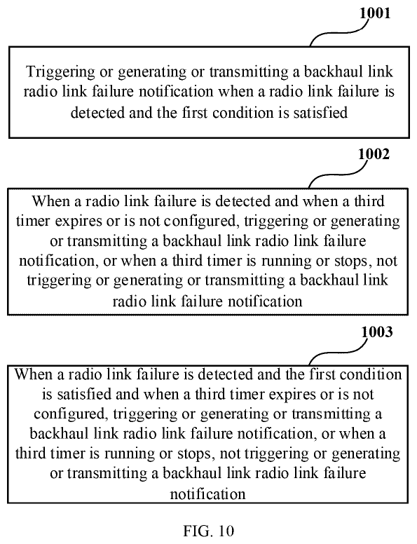

FIG. 10 is another schematic diagram of the method for triggering to generate a backhaul link radio link failure notification of embodiment 1 of this disclosure. As shown in FIG. 10, the method includes:
step 1001: triggering or generating or transmitting a backhaul link radio link failure notification when a radio link failure is detected and the first condition is satisfied; or,
step 1002: when a radio link failure is detected and when a third timer expires or is not configured, triggering or generating or transmitting a backhaul link radio link failure notification, or when a third timer is running or stops, not triggering or generating or transmitting a backhaul link radio link failure notification; or,
step 1003: when a radio link failure is detected and the first condition is satisfied and when a third timer expires or is not configured, triggering or generating or transmitting a backhaul link radio link failure notification, or when a third timer is running or stops, not triggering or generating or transmitting a backhaul link radio link failure notification.

For example, the third timer is a prohibit timer or a hysteresis timer.

In the embodiment of this disclosure, when a backhaul link radio link failure notification is triggered or generated or transmitted, the third timer is started or restarted.

In the embodiment of this disclosure, an RRC layer or BAP layer of the first node triggers or does not trigger the generation of a backhaul link radio link failure notification based on the state of the third timer.

That is, the third timer operates or maintains at the RRC layer or BAP layer.

For example, in the case where the third timer operates or maintains at the RRC layer or BAP layer, the RRC layer takes the state of the third timer into account, such operation, expiration, and stop, etc., so as to determine whether to instruct the BAP to generate a backhaul link radio link failure notification.

In the embodiment of this disclosure, if the third timer operates or maintains at the RRC layer, the RRC triggers or does not trigger generation of a backhaul link radio link failure notification. For example, the RRC instructs the BAP to generate a backhaul link radio link failure notification, or the RRC instructs the BAP not to generate a backhaul link radio link failure notification, or the RRC does not instruct the BAP to generate a backhaul link radio link failure notification.

For example, for the case where the third timer operates or maintains at the RRC layer or BAP layer, when an instruction of the RRC layer is received or an RLF is detected, the BAP takes the state of the timer into account, such operation, expiration, and stop, etc., so as to determine whether to generate or transmit a backhaul link radio link failure notification. Or, the BAP takes the state of the timer into account, such operation, expiration, and stop, etc., so as to determine whether to cancel a triggered backhaul link radio link failure notification.

For example, for a case where only the state of the timer is taken into account, based on the state of the timer, the BAP generates/does not generate or transmits/does not transmit a backhaul link radio link failure notification;
and for other cases, when a radio link failure is detected and/or the first condition is satisfied, the RRC instructs the BAP to generate a backhaul link radio link failure notification; and based on the instruction of the RRC and the state of the third timer, the BAP generates/does not generate or transmits/does not transmit a backhaul link radio link failure notification; or, the BAP takes the radio link failure and/or that the first condition is satisfied into account, and based on the state of the timer, generates/does not generate or transmits/does not transmit a backhaul link radio link failure notification.

In the embodiment of this disclosure, the third timer is stopped when at least one of the following conditions is satisfied:
receiving at least one of an RRCSetup message, an RRCRelease message and a reconfigurationWithSync message;
initiating an RRC connection reestablishment procedure;
going to an RRC-IDLE state;
the reconfiguration WithSync message is included in an spCellConfiguration message of the MAC or SCG, and the MAC of the NR cell group has successfully completed an RA procedure;
release of the second cell group or MR-DC release; and
reconfiguring the third timer.

In the embodiment of this disclosure, a third timer is configured/operated/maintained per IAB-node or per IAB-MT or per cell group (CG) or per use case.

That is, a granularity of the third timer is based on an IAB-node, or an IAB-MT, or a cell group, or a use case.

For the third timer configured/operated/maintained per IAB-node or per IAB-MT, that is, the case where the granularity of the third timer is based on the IAB-node or IAB-MT, a value of the third timer may be configured per IAB-node or per IAB-MT, for example, the value of the third timer is included in IE BWP-UplinkDedicated;
for the third timer configured/operated/maintained per cell group (CG), that is, the case where the granularity of the third timer is based on the cell group (CG), a value of the third timer may be configured per cell group (CG), for example, the value of the third timer is included in a CellGroupConfig IE, or a value of the third timer may be configured per IAB-node or per IAB-MT, for example, the value of the third timer is included in IE BWP-UplinkDedicated;
for the third timer configured/operated/maintained per use case, that is, the case where the granularity of the third timer is based on the use case, a value of the third timer may be configured per use case, for example,
for an RLF, for example, the value of the third timer is included in IE RLF-TimersAndConstants;
and for an HOF, for example, the value of the third timer is included in IE Reconfiguration WithSync;
or, the value of the third timer may be configured per cell group (CG), for example, the value of the third timer is included in a CellGroupConfig IE, or the value of the third timer may be configured per IAB-node or per IAB-MT, for example, the value of the third timer is included in IE BWP-UplinkDedicated;
in addition, for example, that the granularity of the third timer is based on the use cases is only applicable to the case where conditions for determining to trigger or generate or transmit a backhaul link radio link failure notification include the first condition and the state of the third timer;

in addition, for the third timer configured/operated/maintained per use case, that is, the case where the granularity of the third timer is based on the use case, a case where a third X timer is used for an RLF and a third Y timer is used for an HOF. Granularities of the third X timer and the third Y timer are respectively based on an IAB-node or an IAB-MT or a cell group; for example, the third X timer is based on a cell group, and the third Y timer is based on an IAB-node or an IAB-MT.

In step 902, based on the state of the timer, the generation of a backhaul link radio link failure notification is triggered or not triggered. For example,

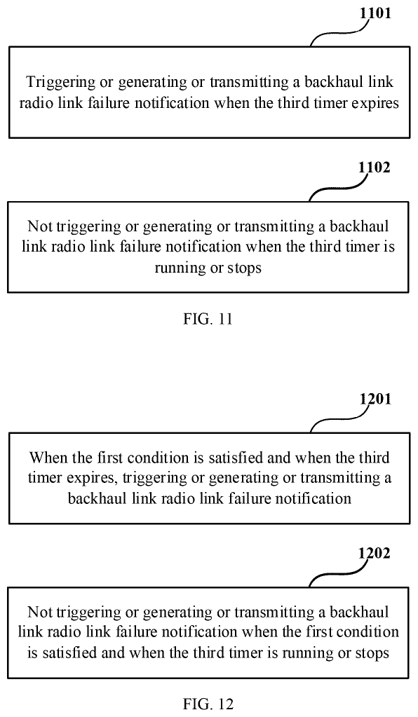

FIG. 11 is a further schematic diagram of the method for triggering to generate a backhaul link radio link failure notification of embodiment 1 of this disclosure. As shown in FIG. 11, the method includes:
step 1101: triggering or generating or transmitting a backhaul link radio link failure notification when the third timer expires, or,
step 1102: not triggering or generating or transmitting a backhaul link radio link failure notification when the third timer is running or stops.

For example, when a type-3 backhaul link radio link failure notification is triggered or generated or transmitted, or when a detected radio link failure is recovered, the third timer is stopped.

For example, the type-3 radio link failure notification indicates that the backhaul link is successfully recovered from the radio link failure, and the type-3 radio link failure notification is carried by the BAP control PDU.

In addition, reference may be made to what is described above for other contents of the third timer, which shall not be repeated herein any further.

In step 903, when the first condition is satisfied, based on the state of the timer, the generation of a backhaul link radio link failure notification is triggered or not triggered. For example,

FIG. 12 is still another schematic diagram of the method for triggering to generate a backhaul link radio link failure notification of embodiment 1 of this disclosure. As shown in FIG. 12, the method includes:
step 1201: when the first condition is satisfied and when the third timer expires, triggering or generating or transmitting a backhaul link radio link failure notification, or,
step 1202: not triggering or generating or transmitting a backhaul link radio link failure notification when the first condition is satisfied and when the third timer is running or stops.

For example, when a type-3 backhaul link radio link failure notification is triggered or generated or transmitted, or when a detected radio link failure is recovered, the third timer is stopped.

For example, the type-3 radio link failure notification indicates that the backhaul link is successfully recovered from the radio link failure, and the type-3 radio link failure notification is carried by the BAP control PDU.

In addition, reference may be made to what is described above for other contents of the third timer, which shall not be repeated herein any further.

In the embodiment of this disclosure, following description shall be given by taking specific scenarios as examples.

Scenario 1) When dual connectivity (DC) is configured, generation of a type-2 RLF indication is triggered when an RLF is detected.

For example, when AS security has been activated and SRB2 has been established, if it is connected as an IAB-node, a lower layer is triggered to initiate a BH RLF indication process;
for another example, in a case where the radio link failure is an SCG radio link failure, if an SCG failure information procedure is not initiated or is unable to be initiated, if it is connected as an LAB-node, a lower layer is triggered to initiate a BH RLF indication process;
for a further example, if the radio link failure is an MCG radio link failure, an MCG failure information procedure is not initiated or is unable to be initiated, if it is connected as an IAB-node, a lower layer is triggered to initiate a BH RLF indication process.

A new standard is, for example,

### 5.3.10.3 Detection of Radio Link Failure

### The UE Shall:

| 1> | if any DAPS bearer is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of retransmissions has been reached; |
| | | or |
| | 2> | upon consistent uplink LBT failure indication from source MCG MAC: |

| | |
|---|---|
| 3> | consider radio link failure to be detected for the source MCG i.e. source RLF; |
| 3> | suspend the transmission and reception of all DRBs in the source MCG; |
| 3> | reset MAC for the source MCG; |
| 3> | release the source connection. |

| 1> | else: | |
|---|---|---|
| | 2> | during a DAPS handover: the following only applies for the target PCell; |
| | 2> | upon T310 expiry in PCell; or |
| | 2> | upon T312 expiry in PCell; or |
| | 2> | upon random access problem indication from MCG MAC while neither T300, T301, T304, T311 nor |
| | | T319 are running; or |
| | 2> | upon indication from MCG RLC that the maximum number of retransmissions has been reached; or |
| | 2> | if connected as an IAB-node, upon BH RLF indication received on BAP entity from the MCG; or |
| | 2> | upon consistent uplink LBT failure indication from MCG MAC while T304 is not running: |

| | |
|---|---|
| 3> | if the indication is from MCG RLC and CA duplication is configured and activated for MCG, and for |
| | the corresponding logical channel allowedServingCells only includes SCell(s): |

| | |
|---|---|
| 4> | initiate the failure information procedure as specified in 5.7.5 to report RLC failure. |

| | |
|---|---|
| 3> | else: |

| | 4> | consider radio link failure to be detected for the MCG, i.e. MCG RLF; |
|---|---|---|
| | 4> | discard any segments of segmented RRC messages stored according to 5.7.6.3; |
| NOTE: | Void. | |
| | 4> | if AS security has not been activated: |

| | |
|---|---|
| 5> | perform the actions upon going to RRC_IDLE as specified in 5.3.11, with release cause |
| | ‘other’;- |

| | |
|---|---|
| 4> | else if AS security has been activated but SRB2 and at least one DRB or, for IAB, SRB2, have not |
| | been setup: |

| | |
|---|---|
| 5> | store the radio link failure information in the VarRLF-Report as described in subclause |
| | 5.3.10.5; |
| 5> | perform the actions upon going to RRC_IDLE as specified in 5.3.11, with release cause ‘RRC |
| | connection failure’; |

| | |
|---|---|
| 4> | else: |

| | |
|---|---|
| 5> | if connected as an IAB-node: |

| | |
|---|---|
| 6> | trigger the lower layer to initiate the BH RLF indication procedure; |

| | |
|---|---|
| 5> | store the radio link failure information in the VarRLF-Report as described in subclause |
| | 5.3.10.5; |
| 5> | if T316 is configured; and |
| 5> | if SCG transmission is not suspended; and |
| 5> | if neither PSCell change nor PSCell addition is ongoing (i.e. timer T304 for the NR PSCell is |
| | not running in case of NR-DC or timer T307 of the E-UTRA PSCell is not running as specified |
| | in TS 36.331 [10], clause 5.3.10.10, in NE-DC): |

| | |
|---|---|
| 6> | initiate the MCG failure information procedure as specified in 5.7.3b to report MCG radio |
| | link failure. |

| | |
|---|---|
| 5> | else: |

| | |
|---|---|
| 6> | initiate the connection re-establishment procedure as specified in 5.3.7. |

### The UE Shall:

| 1> | upon T310 expiry in PSCell; or | |
|---|---|---|
| 1> | upon T312 expiry in PSCell; or | |
| 1> | upon random access problem indication from SCG MAC; or | |
| 1> | upon indication from SCG RLC that the maximum number of retransmissions has been reached; or | |
| 1> | if connected as an IAB-node, upon BH RLF indication received on BAP entity from the SCG; or | |
| 1> | upon consistent uplink LBT failure indication from SCG MAC: | |
| | 2> | if the indication is from SCG RLC and CA duplication is configured and activated for SCG, and for the |
| | | corresponding logical channel allowedServingCells only includes SCell(s): |

| | |
|---|---|
| 3> | initiate the failure information procedure as specified in 5.7.5 to report RLC failure. |

| | |
|---|---|
| 2> | else: |

| | |
|---|---|
| 3> | consider radio link failure to be detected for the SCG, i.e. SCG RLF; |
| 3> | if connected as an IAB-node: |

| | |
|---|---|
| 4> | trigger the lower layer to initiate the BH RLF indication procedure; |

| | |
|---|---|
| 3> | if MCG transmission is not suspended: |

| | |
|---|---|
| 4> | initiate the SCG failure information procedure as specified in 5.7.3 to report SCG radio link |
| | failure. |

| | |
|---|---|
| 3> | else: |

| | |
|---|---|
| 4> | if the UE is in NR-DC: |
| | 5> initiate the connection re-establishment procedure as specified in 5.3.7; |
| 4> | else (the UE is in (NG)EN-DC): |
| | 5> initiate the connection re-establishment procedure as specified in TS 36.331 [10], clause 5.3.7; |

A new standard is, for another example,

### 5.3.10.3 Detection of Radio Link Failure

### The UE Shall:

| 1> | if any DAPS bearer is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of retransmissions has been reached; |
| | | or |
| | 2> | upon consistent uplink LBT failure indication from source MCG MAC: |

| | |
|---|---|
| 3> | consider radio link failure to be detected for the source MCG i.e. source RLF; |
| 3> | suspend the transmission and reception of all DRBs in the source MCG; |
| 3> | reset MAC for the source MCG; |
| 3> | release the source connection. |

| 1> | else: | |
|---|---|---|
| | 2> | during a DAPS handover: the following only applies for the target PCell; |
| | 2> | upon T310 expiry in PCell; or |
| | 2> | upon T312 expiry in PCell; or |
| | 2> | upon random access problem indication from MCG MAC while neither T300, T301, T304, T311 nor |
| | | T319 are running; or |
| | 2> | upon indication from MCG RLC that the maximum number of retransmissions has been reached; or |
| | 2> | if connected as an IAB-node, upon BH RLF indication received on BAP entity from the MCG; or |
| | 2> | upon consistent uplink LBT failure indication from MCG MAC while T304 is not running: |

| | |
|---|---|
| 3> | if the indication is from MCG RLC and CA duplication is configured and activated for MCG, and for |
| | the corresponding logical channel allowedServingCells only includes SCell(s): |

| | |
|---|---|
| 4> | initiate the failure information procedure as specified in 5.7.5 to report RLC failure. |

| | |
|---|---|
| 3> | else: |

| | 4> | consider radio link failure to be detected for the MCG, i.e. MCG RLF; |
|---|---|---|
| | 4> | discard any segments of segmented RRC messages stored according to 5.7.6.3; |
| NOTE: | Void. | |
| | 4> | if AS security has not been activated: |

| | |
|---|---|
| 5> | perform the actions upon going to RRC_IDLE as specified in 5.3.11, with release cause |
| | ‘other’;- |

| | |
|---|---|
| 4> | else if AS security has been activated but SRB2 and at least one DRB or, for IAB, SRB2, have not |
| | been setup: |

| | |
|---|---|
| 5> | store the radio link failure information in the VarRLF-Report as described in subclause |
| | 5.3.10.5; |
| 5> | perform the actions upon going to RRC_IDLE as specified in 5.3.11, with release cause ‘RRC |
| | connection failure’; |

| | |
|---|---|
| 4> | else: |

| | |
|---|---|
| 5> | store the radio link failure information in the VarRLF-Report as described in subclause |
| | 5.3.10.5; |
| 5> | if T316 is configured; and |
| 5> | if SCG transmission is not suspended; and |
| 5> | if neither PSCell change nor PSCell addition is ongoing (i.e. timer T304 for the NR PSCell is |
| | not running in case of NR-DC or timer T307 of the E-UTRA PSCell is not running as specified |
| | in TS 36.331 [10], clause 5.3.10.10, in NE-DC): |

| | |
|---|---|
| 6> | initiate the MCG failure information procedure as specified in 5.7.3b to report MCG radio |
| | link failure. |

| | |
|---|---|
| 5> | else: |

| | |
|---|---|
| 6> | if connected as an IAB-node: |
| | 7> trigger the lower layer to initiate the BH RLF indication procedure; |
| 6> | initiate the connection re-establishment procedure as specified in 5.3.7. |

### The UE Shall:

| 1> | upon T310 expiry in PSCell; or | |
|---|---|---|
| 1> | upon T312 expiry in PSCell; or | |
| 1> | upon random access problem indication from SCG MAC; or | |
| 1> | upon indication from SCG RLC that the maximum number of retransmissions has been reached; or | |
| 1> | if connected as an IAB-node, upon BH RLF indication received on BAP entity from the SCG; or | |
| 1> | upon consistent uplink LBT failure indication from SCG MAC: | |
| | 2> | if the indication is from SCG RLC and CA duplication is configured and activated for SCG, and for the |
| | | corresponding logical channel allowedServingCells only includes SCell(s): |

| | |
|---|---|
| 3> | initiate the failure information procedure as specified in 5.7.5 to report RLC failure. |

| | |
|---|---|
| 2> | else: |

| | |
|---|---|
| 3> | consider radio link failure to be detected for the SCG, i.e. SCG RLF; |
| 3> | if MCG transmission is not suspended: |

| | |
|---|---|
| 4> | initiate the SCG failure information procedure as specified in 5.7.3 to report SCG radio link |
| | failure. |

| | |
|---|---|
| 3> | else: |

| | |
|---|---|
| 4> | if the UE is in NR-DC: |

| | |
|---|---|
| 5> | if connected as an IAB-node: |
| | 6> trigger the lower layer to initiate the BH RLF indication procedure; |
| 5> | initiate the connection re-establishment procedure as specified in 5.3.7; |

| | |
|---|---|
| 4> | else (the UE is in (NG)EN-DC): |

| | |
|---|---|
| 5> | initiate the connection re-establishment procedure as specified in TS 36.331 [10], clause 5.3.7; |

A new standard is, for a further example,

### 5.3.10.3 Detection of Radio Link Failure

### The UE Shall:

| 1> | if any DAPS bearer is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of retransmissions has been reached; |
| | | or |
| | 2> | upon consistent uplink LBT failure indication from source MCG MAC: |
| | | 3> consider radio link failure to be detected for the source MCG i.e. source RLF; |
| | | 3> suspend the transmission and reception of all DRBs in the source MCG; |
| | | 3> reset MAC for the source MCG; |
| | | 3> release the source connection. |
| 1> | else: | |
| | 2> | during a DAPS handover: the following only applies for the target PCell; |
| | 2> | upon T310 expiry in PCell; or |
| | 2> | upon T312 expiry in PCell; or |
| | 2> | upon random access problem indication from MCG MAC while neither T300, T301, T304, T311 nor |
| | | T319 are running; or |
| | 2> | upon indication from MCG RLC that the maximum number of retransmissions has been reached; or |
| | 2> | if connected as an IAB-node, upon BH RLF indication received on BAP entity from the MCG; or |
| | 2> | upon consistent uplink LBT failure indication from MCG MAC while T304 is not running: |

| | |
|---|---|
| 3> | if the indication is from MCG RLC and CA duplication is configured and activated for MCG, and for |
| | the corresponding logical channel allowedServingCells only includes SCell(s): |

| | |
|---|---|
| 4> | initiate the failure information procedure as specified in 5.7.5 to report RLC failure. |

| | |
|---|---|
| 3> | else: |

| | 4> | consider radio link failure to be detected for the MCG, i.e. MCG RLF; |
|---|---|---|
| | 4> | discard any segments of segmented RRC messages stored according to 5.7.6.3; |
| NOTE: | Void. | |
| | 4> | if AS security has not been activated: |

| | |
|---|---|
| 5> | perform the actions upon going to RRC_IDLE as specified in 5.3.11, with release cause |
| | ‘other’;- |

| | |
|---|---|
| 4> | else if AS security has been activated but SRB2 and at least one DRB or, for IAB, SRB2, have not |
| | been setup: |

| | |
|---|---|
| 5> | store the radio link failure information in the VarRLF-Report as described in subclause |
| | 5.3.10.5; |
| 5> | perform the actions upon going to RRC_IDLE as specified in 5.3.11, with release cause ‘RRC |
| | connection failure’; |

| | |
|---|---|
| 4> | else: |

| | |
|---|---|
| 5> | store the radio link failure information in the VarRLF-Report as described in subclause |
| | 5.3.10.5; |
| 5> | if T316 is configured; and |
| 5> | if SCG transmission is not suspended; and |
| 5> | if neither PSCell change nor PSCell addition is ongoing (i.e. timer T304 for the NR PSCell is |
| | not running in case of NR-DC or timer T307 of the E-UTRA PSCell is not running as specified |
| | in TS 36.331 [10], clause 5.3.10.10, in NE-DC): |

| | |
|---|---|
| 6> | initiate the MCG failure information procedure as specified in 5.7.3b to report MCG radio |
| | link failure. |

| | |
|---|---|
| 5> | else: |

| | |
|---|---|
| 6> | trigger the lower layer to initiate the BH RLF indication procedure; |
| 6> | initiate the connection re-establishment procedure as specified in 5.3.7. |

### The UE Shall:

| 1> | upon T310 expiry in PSCell; or | |
|---|---|---|
| 1> | upon T312 expiry in PSCell; or | |
| 1> | upon random access problem indication from SCG MAC; or | |
| 1> | upon indication from SCG RLC that the maximum number of retransmissions has been reached; or | |
| 1> | if connected as an IAB-node, upon BH RLF indication received on BAP entity from the SCG; or | |
| 1> | upon consistent uplink LBT failure indication from SCG MAC: | |
| | 2> | if the indication is from SCG RLC and CA duplication is configured and activated for SCG, and for the |
| | | corresponding logical channel allowedServingCells only includes SCell(s): |

| | |
|---|---|
| 3> | initiate the failure information procedure as specified in 5.7.5 to report RLC failure. |

| | |
|---|---|
| 2> | else: |

| | |
|---|---|
| 3> | consider radio link failure to be detected for the SCG, i.e. SCG RLF; |
| 3> | if MCG transmission is not suspended: |

| | |
|---|---|
| 4> | initiate the SCG failure information procedure as specified in 5.7.3 to report SCG radio link |
| | failure. |

| | |
|---|---|
| 3> | else: |

| | |
|---|---|
| 4> | if the UE is in NR-DC: |
| | 5> trigger the lower layer to initiate the BH RLF indication procedure; |
| | 5> initiate the connection re-establishment procedure as specified in 5.3.7; |
| 4> | else (the UE is in (NG)EN-DC): |

| | |
|---|---|
| 5> | initiate the connection re-establishment procedure as specified in TS 36.331 [10], clause 5.3.7; |

In the embodiment of this disclosure, the UE (user equipment) in the above standards is, for example, an IAB-MT.

In addition, in the embodiments of this disclosure, the communication system in the above standards may include a UE (user equipment) and a network node, wherein the UE includes an IAB-MT.

Hence, in the case where the LAB-node is configured with dual connectivity or multi-connectivity, by further limiting conditions for generating a type-2 RLF indication and reducing generation of type-2 RLF indications, RLF indication storms in the case of dual connectivity or multi-connectivity may be avoided, resource overhead may be lowered and security risks may be reduced.

Scenario 2) Generation of a type-2 RLF indication is triggered when a source RLF is detected during DAPS HO. Furthermore,

A new standard is, for example,

### 5.3.10.3 Detection of Radio Link Failure

### The UE Shall:

| 1> | if any DAPS bearer is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of retransmissions has been reached; |
| | | or |
| | 2> | upon consistent uplink LBT failure indication from source MCG MAC: |

| | |
|---|---|
| 3> | consider radio link failure to be detected for the source MCG i.e. source RLF; |
| 3> | if connected as an IAB-node: |
| | 4> trigger the lower layer for the source MCG to initiate the BH RLF indication procedure; |
| 3> | suspend the transmission and reception of all DRBs in the source MCG; |
| 3> | reset MAC for the source MCG; |
| 3> | release the source connection. |

Furthermore, for generation of a type-3 RLF indication,

5.3.5.8.3 T304 Expiry (Reconfiguration with Sync Failure)

### The UE Shall:

| 1> | if T304 of the MCG expires: | |
|---|---|---|
| | 2> | release dedicated preambles provided in rach-ConfigDedicated if configured; |
| | 2> | release dedicated msgA PUSCH resources provided in rach-ConfigDedicated if configured; |
| | 2> | if any DAPS bearer is configured, and radio link failure is not detected in the source PCell, according to |
| | | subclause 5.3.10.3: |

| | |
|---|---|
| 3> | if connected as an IAB-node: |

| | |
|---|---|
| 4> | trigger the lower layer for the source MCG to initiate the BH RLF indication procedure; |

| | |
|---|---|
| 3> | reset MAC for the target PCell and release the MAC configuration for the target PCell; |
| 3> | for each DAPS bearer: |

| | |
|---|---|
| 4> | release the RLC entity or entities as specified in TS 38.322 [4], clause 5.1.3, and the associated |
| | logical channel for the target PCell; |
| 4> | reconfigure the PDCP entity to release DAPS as specified in TS 38.323 [5]; |

| | |
|---|---|
| 3> | for each SRB: |

| | |
|---|---|
| 4> | if the masterKeyUpdate was not received: |

| | |
|---|---|
| 5> | configure the PDCP entity for the source PCell with state variables continuation as specified in |
| | TS 38.323 [5], the state variables as the PDCP entity for the target PCell; |

| | |
|---|---|
| 4> | release the PDCP entity for the target PCell; |
| 4> | release the RLC entity as specified in TS 38.322 [4], clause 5.1.3, and the associated logical |
| | channel for the target PCell; |
| 4> | trigger the PDCP entity for the source PCell to perform SDU discard as specified in TS 38.323 [5]; |
| 4> | re-establish the RLC entity for the source PCell; |

| | |
|---|---|
| 3> | release the physical channel configuration for the target PCell; |
| 3> | revert back to the SDAP configuration used in the source PCell; |
| 3> | discard the keys used in target PCell (the K_{gNB} key, the K_{RRCenc} key, the K_{RRCint} key, the K_{UPint} key and |
| | the K_{UPenc} key), if any; |
| 3> | resume suspended SRBs in the source PCell; |
| 3> | for each non DAPS bearer: |

| | |
|---|---|
| 4> | revert back to the UE configuration used for the DRB in the source PCell, includes PDCP, RLC |
| | states variables, the security configuration and the data stored in transmission and reception buffers |
| | in PDCP and RLC entities ; |

| | |
|---|---|
| 3> | revert back to the UE measurement configuration used in the source PCell; |
| 3> | initiate the failure information procedure as specified in subclause 5.7.5 to report DAPS handover |
| | failure. |

| | |
|---|---|
| 2> | else: |

| | |
|---|---|
| 3> | revert back to the UE configuration used in the source PCell; |
| 3> | store the handover failure information in VarRLF-Report as described in the subclause 5.3.10.5; |
| 3> | initiate the connection re-establishment procedure as specified in subclause 5.3.7. |

| NOTE 1: | In the context above, “the UE configuration” includes state variables and parameters of each radio |
|---|---|
| | bearer. |

| 1> | else if T304 of a secondary cell group expires: | |
|---|---|---|
| | 2> | if MCG transmission is not suspended: |

| | |
|---|---|
| 3> | release dedicated preambles provided in rach-ConfigDedicated, if configured; |
| 3> | initiate the SCG failure information procedure as specified in subclause 5.7.3 to report SCG |
| | reconfiguration with sync failure, upon which the RRC reconfiguration procedure ends; |

| | |
|---|---|
| 2> | else: |

| | |
|---|---|
| 3> | if the UE is in NR-DC: |

| | |
|---|---|
| 4> | initiate the connection re-establishment procedure as specified in subclause 5.3.7; |

| | |
|---|---|
| 3> | else (the UE is in (NG) EN-DC): |

| | |
|---|---|
| 4> | initiate the connection re-establishment procedure as specified in TS 36.331 [10], subclause 5.3.7; |

| 1> | else if T304 expires when RRCReconfiguration is received via other RAT (HO to NR failure): | |
|---|---|---|
| | 2> | reset MAC; |
| | 2> | perform the actions defined for this failure case as defined in the specifications applicable for the other |
| | | RAT. |

| | |
|---|---|
| NOTE 2: | In this clause, the term ‘handover failure’ has been used to refer to ‘reconfiguration with sync failure’. |

A new standard is, for another example,

### 5.3.10.3 Detection of Radio Link Failure

### The UE Shall:

| 1> | if any DAPS bearer/BH RLC channel is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of retransmissions has been reached; |
| | | or |
| | 2> | upon consistent uplink LBT failure indication from source MCG MAC: |

| | |
|---|---|
| 3> | consider radio link failure to be detected for the source MCG i.e. source RLF; |
| 3> | if any DAPS BH RLC channel is configured: |
| | 4> trigger the lower layer for the source MCG to initiate the BH RLF indication procedure; |
| 3> | suspend the transmission and reception of all DRBs in the source MCG; |
| 3> | reset MAC for the source MCG; |
| 3> | release the source connection. |

Furthermore, for generation of a type-3 RLF indication,

5.3.5.8.3 T304 Expiry (Reconfiguration with Sync Failure)

### The UE Shall:

| 1> | if T304 of the MCG expires: | |
|---|---|---|
| | 2> | release dedicated preambles provided in rach-ConfigDedicated if configured; |
| | 2> | release dedicated msgA PUSCH resources provided in rach-ConfigDedicated if configured; |
| | 2> | if any DAPS bearer is configured, and radio link failure is not detected in the source PCell, according to |
| | | subclause 5.3.10.3: |

| | |
|---|---|
| 3> | reset MAC for the target PCell and release the MAC configuration for the target PCell; |
| 3> | if any DAPS BH RLC channel is configured: |

| | |
|---|---|
| 4> | trigger the lower layer for the source MCG to initiate the BH RLF indication procedure; |

| | |
|---|---|
| 3> | for each DAPS bearer: |

| | |
|---|---|
| 4> | release the RLC entity or entities as specified in TS 38.322 [4], clause 5.1.3, and the associated |
| | logical channel for the target PCell; |
| 4> | reconfigure the PDCP entity to release DAPS as specified in TS 38.323 [5]; |

| | |
|---|---|
| 3> | for each SRB: |

| | |
|---|---|
| 4> | if the masterKeyUpdate was not received: |

| | |
|---|---|
| 5> | configure the PDCP entity for the source PCell with state variables continuation as specified in |
| | TS 38.323 [5], the state variables as the PDCP entity for the target PCell; |

| | |
|---|---|
| 4> | release the PDCP entity for the target PCell; |
| 4> | release the RLC entity as specified in TS 38.322 [4], clause 5.1.3, and the associated logical |
| | channel for the target PCell; |
| 4> | trigger the PDCP entity for the source PCell to perform SDU discard as specified in TS 38.323 [5]; |
| 4> | re-establish the RLC entity for the source PCell; |

| | |
|---|---|
| 3> | release the physical channel configuration for the target PCell; |
| 3> | revert back to the SDAP configuration used in the source PCell; |
| 3> | discard the keys used in target PCell (the K_{gNB} key, the K_{RRCenc} key, the K_{RRCint} key, the K_{UPint} key and |
| | the K_{UPenc} key), if any; |
| 3> | resume suspended SRBs in the source PCell; |
| 3> | for each non DAPS bearer: |

| | |
|---|---|
| 4> | revert back to the UE configuration used for the DRB in the source PCell, includes PDCP, RLC |
| | states variables, the security configuration and the data stored in transmission and reception buffers |
| | in PDCP and RLC entities ; |

| | |
|---|---|
| 3> | revert back to the UE measurement configuration used in the source PCell; |
| 3> | initiate the failure information procedure as specified in subclause 5.7.5 to report DAPS handover |
| | failure. |

| | |
|---|---|
| 2> | else: |

| | |
|---|---|
| 3> | revert back to the UE configuration used in the source PCell; |
| 3> | store the handover failure information in VarRLF-Report as described in the subclause 5.3.10.5; |
| 3> | initiate the connection re-establishment procedure as specified in subclause 5.3.7. |

| NOTE 1: | In the context above, “the UE configuration” includes state variables and parameters of each radio |
|---|---|
| | bearer. |

| 1> | else if T304 of a secondary cell group expires: | |
|---|---|---|
| | 2> | if MCG transmission is not suspended: |

| | |
|---|---|
| 3> | release dedicated preambles provided in rach-ConfigDedicated, if configured; |
| 3> | initiate the SCG failure information procedure as specified in subclause 5.7.3 to report SCG |
| | reconfiguration with sync failure, upon which the RRC reconfiguration procedure ends; |

| | |
|---|---|
| 2> | else: |

| | |
|---|---|
| 3> | if the UE is in NR-DC: |

| | |
|---|---|
| 4> | initiate the connection re-establishment procedure as specified in subclause 5.3.7; |

| | |
|---|---|
| 3> | else (the UE is in (NG) EN-DC): |

| | |
|---|---|
| 4> | initiate the connection re-establishment procedure as specified in TS 36.331 [10], subclause 5.3.7; |

| 1> | else if T304 expires when RRCReconfiguration is received via other RAT (HO to NR failure): | |
|---|---|---|
| | 2> | reset MAC; |
| | 2> | perform the actions defined for this failure case as defined in the specifications applicable for the other |
| | | RAT. |

| | |
|---|---|
| NOTE 2: | In this clause, the term ‘handover failure’ has been used to refer to ‘reconfiguration with sync failure’. |

Hence, in the case where the IAB-node performs DAPS handover or migration, by further limiting conditions for generating a type-2 RLF indication and reducing generation of type-2 RLF indications, RLF indication storms in the source side may be avoided, resource overhead may be lowered and security risks may be reduced.

It can be seen from the above embodiment that by limiting triggering the generation of a backhaul link radio link failure notifications, RLF indication storms may be avoided, resource overhead may be lowered and security risks may be reduced.

### Embodiment 2

The embodiment of this disclosure provides a method for triggering to generate a backhaul link radio link failure notification, applicable to a first node.

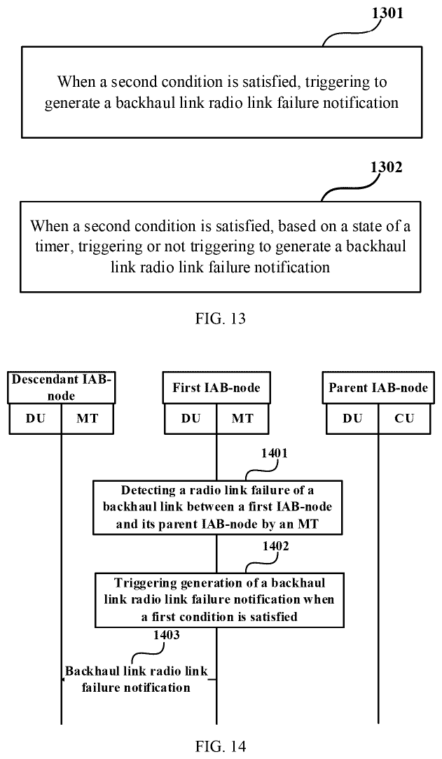

FIG. 13 is a schematic diagram of the method for triggering to generate a backhaul link radio link failure notification of embodiment 2 of this disclosure. As shown in FIG. 13, the method includes:
step 1301: when a second condition is satisfied, triggering to generate a backhaul link radio link failure notification; or,
step 1302: when a second condition is satisfied, based on a state of a timer, triggering or not triggering to generate a backhaul link radio link failure notification,
the second condition including at least one of the following that:
a first timer expires;
a second timer expires;
RRC connection reconfiguration fails; and
an integrity check failure indication from a lower layer is received.

In the embodiment of this disclosure, the first timer is timer T316, and/or, the second timer is timer T304.

For example, a network configures a value of the first timer only when an IAB-node or IAB-MT is configured with split SRB1 or SRB3.

For example, the first timer is started when an MCGFailureInformation message is sent or transmitted.

For example, the first timer is stopped when an RRCRelease message or an RRCReconfiguration message with reconfigurationwithSync of a PCell or an MobilityFromNRCommand message is received or an RRC connection reestablishment procedure is initiated.

In the embodiment of this disclosure, that the second timer expires includes that,
in a case where the RRCReconfiguration message is not received from another RAT,
a second timer of an MCG expires and no DAPS bearer or dual protocol stack backhaul link RLC channel is configured; or, a radio link failure is detected in a source PCell; or,
a second timer of an SCG expires, NR-DC is used and MCG transmission is suspended.

In the embodiment of this disclosure, when the RRCReconfiguration message including reconfigurationWithSync or a conditional reconfiguration execution message is received, the second timer is started.

In the embodiment of this disclosure, when random access or SCG release on a corresponding special cell is successfully completed, the second timer is stopped.

In the embodiment of this disclosure, that the RRC connection reconfiguration fails includes that,
in a case where the RRCReconfiguration is received via NR and the IAB-node or IAB-MT is not EN-DC,
the IAB-node or IAB-MT uses NR SA or NE-DC or NR-DC, and the IAB-node or IAB-MT is unable to comply with a part of configurations or embedded SCG configuration included in the RRCReconfiguration message received via SRB1, or a combination of a part of MCG configurations and a part of SCG configurations, or embedded V2X sidelink configuration, or a higher layer indicates that nas-Container is invalid, and AS security has been activated and SRB2 has been established; and/or,
the IAB-node or IAB-MT uses NR SA or NR-DC, and the IAB-node or IAB-MT is unable to comply with a part of configurations included in the RRCReconfiguration message received via SRB3, and MCG transmission is suspended.

In the embodiment of this disclosure, the integrity check failure indication from the lower layer includes at least one of the following:
an integrity check failure from a physical layer, such as DCI, or a PDCCH;
an integrity check failure from an MAC sublayer, such as an SCell activation MAC CE integrity check failure;
an integrity check failure from an RLC sublayer, such as an RLC control PDU; and
an integrity check failure from a BAP sublayer, such as a BAP control PDU.

In the embodiment of this disclosure, the first node is connected as an IAB-node, or the first node is an IAB-node.

In the embodiment of this disclosure, the backhaul link radio link failure notification is a type-2 radio link failure notification.

In the embodiment of this disclosure, that when the second condition is satisfied, based on the state of the timer, triggering or not triggering generation of a backhaul link radio link failure notification, includes:
when the second condition is satisfied, and when a fourth timer expires or is not configured, triggering or generating or transmitting a backhaul link radio link failure notification, or when a fourth timer is running or stops, not triggering or generating or transmitting a backhaul link radio link failure notification.

In the embodiment of this disclosure, when a backhaul link radio link failure notification is triggered or generated or transmitted, the fourth timer is started or restarted.

In the embodiment of this disclosure, based on the state of the fourth timer, an RRC layer or BAP layer of the first node triggers or does not trigger generation of a backhaul link radio link failure notification.

In the embodiment of this disclosure, the fourth timer is stopped when at least one of the following conditions is satisfied:
receiving at least one of an RRCSetup message, an RRCRelease message and a reconfiguration WithSync message;
initiating an RRC connection reestablishment procedure;
going to an RRC-IDLE state;
the reconfigurationWithSync message is included in an spCellConfiguration message of the MAC or SCG, and the MAC of the NR cell group has successfully completed an RA procedure;
release of the second cell group or MR-DC release; and
reconfiguring the fourth timer.

In the embodiment of this disclosure, a fourth timer is configured per IAB-node, or per IAB-MT, or per cell group, or per use case.

In the embodiment of this disclosure, the fourth timer is a prohibit timer or a hysteresis timer.

In the embodiment of this disclosure, reference may be made to what is described in embodiment 1 for contents identical or related to those in embodiment 1, which shall not be repeated herein any further.

It can be seen from the above embodiment that by limiting triggering the generation of a backhaul link radio link failure notifications, RLF indication storms may be avoided, resource overhead may be lowered and security risks may be reduced.

### Embodiment 3

The embodiment of this disclosure provides a method for triggering to generate a backhaul link radio link failure notification, applicable to a first node, i.e. a first IAB-node, a descendant node of the first IAB-node and a parent IAB-node of the first IAB-node. This method corresponds to the method of embodiment 1.

FIG. 14 is a schematic diagram of the method for triggering to generate a backhaul link radio link failure notification of embodiment 3 of this disclosure. As shown in FIG. 14, the method includes:
step 1401: detecting a radio link failure of a backhaul link between a first IAB-node and its parent IAB-node by an MT of the first IAB-node;
step 1402: triggering generation of a backhaul link radio link failure notification when a first condition is satisfied; and
step 1403: transmitting the backhaul link radio link failure notification by a DU of the first IAB-node to a descendant IAB-node of the first IAB-node.

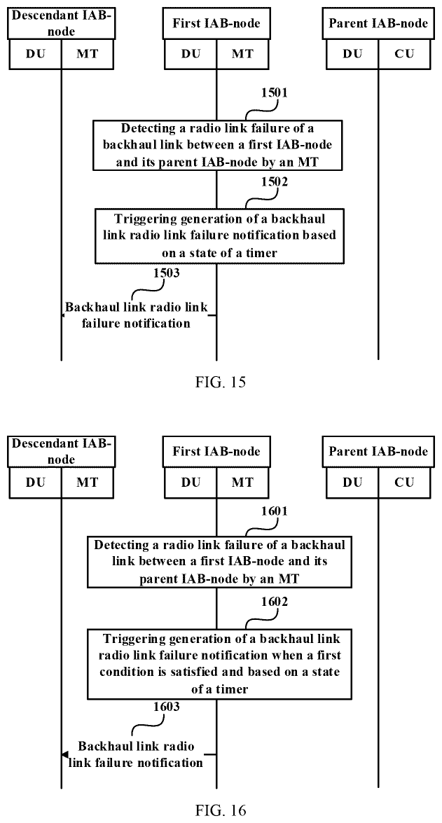

FIG. 15 is a schematic diagram of the method for triggering to generate a backhaul link radio link failure notification of embodiment 3 of this disclosure. As shown in FIG. 15, the method includes:
step 1501: detecting a radio link failure of a backhaul link between a first IAB-node and its parent IAB-node by an MT of the first IAB-node;
step 1502: triggering generation of a backhaul link radio link failure notification based on a state of a timer; and
step 1503: transmitting the backhaul link radio link failure notification by a DU of the first IAB-node to a descendant IAB-node of the first IAB-node.

FIG. 16 is a schematic diagram of the method for triggering to generate a backhaul link radio link failure notification of embodiment 3 of this disclosure. As shown in FIG. 16, the method includes:
step 1601: detecting a radio link failure of a backhaul link between a first IAB-node and its parent IAB-node by an MT of the first IAB-node;
step 1602: triggering generation of a backhaul link radio link failure notification when a first condition is satisfied and based on a state of a timer; and
step 1603: transmitting the backhaul link radio link failure notification by a DU of the first IAB-node to a descendant IAB-node of the first IAB-node.

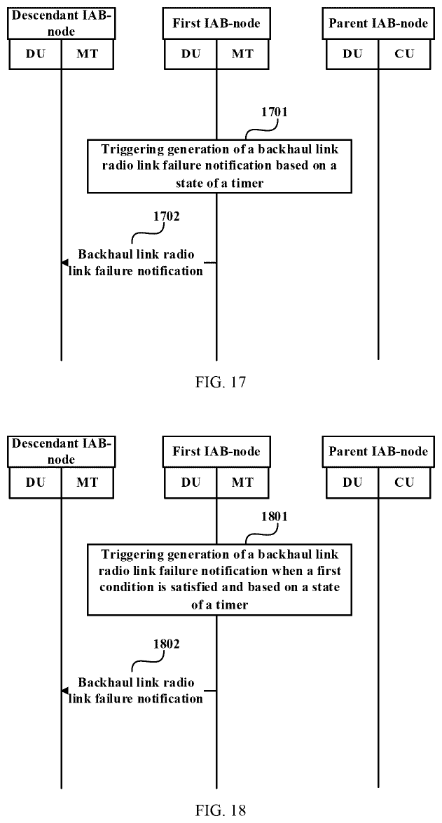

FIG. 17 is a schematic diagram of the method for triggering to generate a backhaul link radio link failure notification of embodiment 3 of this disclosure. As shown in FIG. 17, the method includes:
step 1701: triggering generation of a backhaul link radio link failure notification based on a state of a timer; and
step 1702: transmitting the backhaul link radio link failure notification by a DU of the first IAB-node to a descendant IAB-node of the first IAB-node.

FIG. 18 is a schematic diagram of the method for triggering to generate a backhaul link radio link failure notification of embodiment 3 of this disclosure. As shown in FIG. 18, the method includes:
step 1801: triggering generation of a backhaul link radio link failure notification when a first condition is satisfied and based on a state of a timer; and
step 1802: transmitting the backhaul link radio link failure notification by a DU of the first IAB-node to a descendant IAB-node of the first IAB-node.

In the embodiment of this disclosure, reference may be made to what is described in embodiment 1 for specific implementations of the above steps, which shall not be repeated herein any further.

It can be seen from the above embodiment that by limiting triggering the generation of a backhaul link radio link failure notifications, RLF indication storms may be avoided, resource overhead may be lowered and security risks may be reduced.

### Embodiment 4

The embodiment of this disclosure provides an apparatus for triggering to generate a backhaul link radio link failure notification, applicable to a first node. The apparatus corresponds to the method described in embodiment 1.

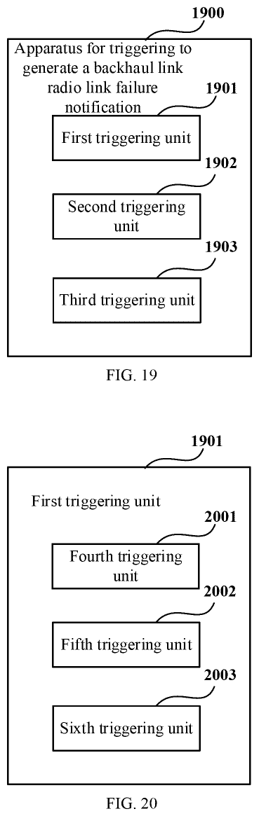

FIG. 19 is a schematic diagram of the apparatus for triggering to generate a backhaul link radio link failure notification of embodiment 4 of this disclosure. As shown in FIG. 19, an apparatus 1900 includes:

a first triggering unit 1901 configured to, when a radio link failure is detected and when a first condition is satisfied and/or based on a state of a timer, trigger or not to trigger to generate a backhaul link radio link failure notification; or,
a second triggering unit 1902 configured to trigger or not to trigger to generate a backhaul link radio link failure notification based on a state of a timer; or,
a third triggering unit 1903 configured to, when a first condition is satisfied, trigger or not to trigger to generate a backhaul link radio link failure notification based on a state of a timer.

In the embodiment of this disclosure, the first node is connected as an IAB-node, or the first node is an IAB-node.

In the embodiment of this disclosure, that the first node is connected as an IAB-node, or the first node is an IAB-node, includes at least one of the following that:
in a connection establishment procedure, the first node is accessed to the network as an IAB-node;
in a procedure of adding and/or updating a secondary node, the first node is connected to the secondary node as an IAB-node;
the first node serves for a descendant node or a terminal equipment as an IAB-node;
at least one connected IAB-node serves as a descendant node of the first node; and
at least one connected IAB-node has established a backhaul link RLC channel with the first node.

In the embodiment of this disclosure, the first condition may include that AS security has been activated and SRB2 has been established.

In the embodiment of this disclosure of this disclosure, the first condition further includes at least one of the following that:
in a case where the first node is configured with and/or uses dual connectivity and the radio link failure is an SCG radio link failure, an SCG failure information procedure is not initiated or is unable to be initiated;
in a case where the first node is configured with and/or uses dual connectivity and the radio link failure is an MCG radio link failure, a MCG failure information procedure is not initiated or is unable to be initiated; and
the first node is performing handover or migration.

In the embodiment of this disclosure, that an SCG failure information procedure is not initiated or is unable to be initiated includes at least one of the following that:
the SCG failure information is unable to be reported to an IAB-donor of the first node via an F1 interface message;
the dual connectivity is NR-DC; and
MCG transmission is suspended, or an MCG failure information procedure is initiated.

In the embodiment of this disclosure, that an MCG failure information procedure is not initiated or is unable to be initiated includes at least one of the following that:
the MCG failure information is unable to be reported to an IAB-donor of the first node via an F1 interface message;
a first timer is not configured;
SCG transmission is suspended; and PSCell change or PSCell increase is being performed.

In the embodiment of this disclosure, that the first node is performing handover or migration includes that:

in a case where a second timer is running, when two protocol stacks are used to connect with a source parent node and a target parent node respectively, the two protocol stacks belong to one MT logical entity of the first node.

In the embodiment of this disclosure, that the first node is performing handover or migration includes that:
in a case where a second timer is running, when two protocol stacks are used to connect with a source parent node and a target parent node respectively, the two protocol stacks belong to two MT logical entities of the first node.

In the embodiment of this disclosure, the two protocol stacks correspond to a backhaul link RLC channel.

In the embodiment of this disclosure, that the two protocol stacks are used to connect with a source parent node and a target parent node respectively indicates that any dual protocol stack backhaul link RLC channel is configured.

For example, a first domain in IE BH-RLC-ChannelConfig is used to indicate that a BH RLC channel between the first node and its parent node is configured as a dual protocol stack BH RLC channel.

In the embodiment of this disclosure, the two protocol stacks correspond to RRC bearers.

In the embodiment of this disclosure, that the two protocol stacks are respectively connected to the source parent node and the target parent node indicates that any dual protocol stack bearer is configured.

For example, a second domain in IE DRB-ToAddMod is used to indicate that a bearer is configured as a dual stack bearer.

In the embodiment of this disclosure, when the radio link failure is a source radio link failure, generation of the backhaul link radio link failure notification is not triggered.

In the embodiment of this disclosure, when the radio link failure is a source radio link failure, generation of the backhaul link radio link failure notification is triggered, wherein,
when no radio link failure is detected in the source PCell and the second timer of the MCG expires, generation of a type-3 radio link failure notification is triggered in a protocol stack connected to the source parent node; and/or,
when a radio link failure is successfully recovered or when the handover or migration of the first node is completed successfully, generation of a type-3 radio link failure notification is triggered in a protocol stack connected to a target parent node.

In the embodiment of this disclosure, the type-3 radio link failure notification indicates that the backhaul link has successfully recovered from the radio link failure, and the type-3 radio link failure notification is carried by the BAP control PDU.

In the embodiment of this disclosure, that the handover or migration of the first node is completed successfully includes at least one of the following:
the first node is synchronized to a target cell;
the first node successfully completes random access in the target cell;
the first node transmits an RRCReconfigurationComplete message;
the first node receives an explicit indication of L1 or L2, the indication being used to indicate that a source cell portion operated by the dual protocol stack is to be stopped and/or a source cell portion configured by the dual protocol stack is to be released; and
the first node has already released the source cell, as explicitly requested by the target node.

In the embodiment of this disclosure, when the radio link failure is a target radio link failure,
when the target radio link failure is detected and the first condition is satisfied and/or based on the timer state, the generation of the backhaul link radio link failure notification is triggered or not triggered; or,
based on the state of the timer, the generation of the backhaul link radio link failure notification is triggered or not triggered; or,
when the first condition is satisfied, based on the state of the timer, the generation of the backhaul link radio link failure notification is triggered or not triggered.

FIG. 20 is a schematic diagram of the first triggering unit of embodiment 4 of this disclosure. As shown in FIG. 20, the first triggering unit 1901 includes:

a fourth triggering unit 2001 configured to trigger or generate or transmit a backhaul link radio link failure notification when a radio link failure is detected and the first condition is satisfied; or, a fifth triggering unit 2002 configured to, when a radio link failure is detected and when a third timer expires or is not configured, trigger or generate or transmit a backhaul link radio link failure notification, or when a third timer is running or stops, not to trigger or generate or transmit a backhaul link radio link failure notification; or,
a sixth triggering unit 2003 configured to, when a radio link failure is detected and the first condition is satisfied and when a third timer expires or is not configured, trigger or generate or transmit a backhaul link radio link failure notification, or when a third timer is running or stops, not to trigger or generate or transmit a backhaul link radio link failure notification.

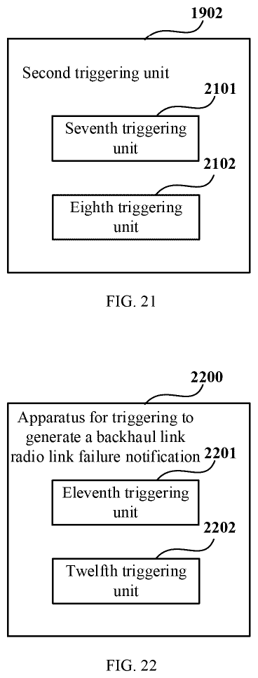

FIG. 21 is a schematic diagram of the second triggering unit of embodiment 4 of this disclosure. As shown in FIG. 21, the second triggering unit 1902 includes:
a seventh triggering unit 2101 configured to trigger or generate or transmit a backhaul link radio link failure notification when the third timer expires, or,
an eighth triggering unit 2102 configured not to trigger or generate or transmit a backhaul link radio link failure notification when the third timer is running or stops.

In the embodiment of this disclosure, the third timer is stopped when a type-3 backhaul link radio link failure notification is triggered or generated or transmitted, or when the detected radio link failure is recovered.

In the embodiment of this disclosure, the third triggering unit 1903 includes:
a ninth triggering unit configured to, when the first condition is satisfied and when the third timer expires, trigger or generate or transmit a backhaul link radio link failure notification, or,
a tenth triggering unit configured not to trigger or generate or transmit a backhaul link radio link failure notification when the first condition is satisfied and when the third timer is running or stops.

In the embodiment of this disclosure, when a type-3 backhaul link radio link failure notification is triggered or generated or transmitted, or when a detected radio link failure is recovered, the third timer is stopped.

In the embodiment of this disclosure, when a backhaul link radio link failure notification is triggered or generated or transmitted, the third timer is started or restarted.

In the embodiment of this disclosure, an RRC layer or a BAP layer of the first node triggers or does not trigger to generate a backhaul link radio link failure notification based on a state of the third timer.

In the embodiment of this disclosure, the third timer is stopped when at least one of the following conditions is satisfied:
receiving at least one of an RRCSetup message, an RRCRelease message and a reconfiguration WithSync message;
initiating an RRC connection reestablishment procedure;
going to an RRC-IDLE state;
the reconfiguration WithSync message is included in an spCellConfiguration message of the MAC or SCG, and the MAC of the NR cell group has successfully completed an RA procedure;
release of the second cell group or MR-DC release; and
reconfiguring the third timer.

In the embodiment of this disclosure, a third timer is configured/operated/maintained per IAB-node or per IAB-MT or per cell group (CG) or per use case.

In the embodiment of this disclosure, the third timer is a prohibit timer or a hysteresis timer.

In the embodiment of this disclosure, the backhaul link radio link failure notification is a type-2 or type-1 radio link failure notification.

In the embodiment of this disclosure, the type-2 radio link failure notification is used to indicate that the first node detects that a backhaul link radio link fails and the first node is attempting to recover from the backhaul link radio link failure,
the type-1 radio link failure notification is used to indicate that the first node detects that a backhaul link radio link fails,
and the type-2 or type-1 radio link failure notification is carried by a BAP control PDU.

In the embodiment of this disclosure, the first timer is timer T316.

In the embodiment of this disclosure, the second timer is timer T304.

In the embodiment of this disclosure, reference may be made to implementations of relevant steps in embodiment 1 for implementations of functions of the above units, which shall not be repeated herein any further.

It can be seen from the above embodiment that by limiting triggering the generation of a backhaul link radio link failure notifications, RLF indication storms may be avoided, resource overhead may be lowered and security risks may be reduced.

### Embodiment 5

The embodiment of this disclosure provides an apparatus for triggering to generate a backhaul link radio link failure notification, applicable to a first node. The apparatus corresponds to the method described in embodiment 2.

FIG. 22 is a schematic diagram of the apparatus for triggering to generate a backhaul link radio link failure notification of embodiment 5 of this disclosure. As shown in FIG. 22, an apparatus 2200 includes:
an eleventh triggering unit 2201 configured to trigger generation of a backhaul link radio link failure notification when a second condition is satisfied, or,
a twelfth triggering unit 2202 configured to, when a second condition is satisfied, based on a state of a timer, trigger or not to trigger generation of a backhaul link radio link failure notification. The second condition includes at least one of the following that:
a first timer expires;
a second timer expires;
RRC connection reconfiguration fails; and
an integrity check failure indication from a lower layer is received.

In the embodiment of this disclosure, a network configures a value of the first timer only when an IAB-node or IAB-MT is configured with split SRB1 or SRB3.

In the embodiment of this disclosure, the first timer is started when an MCGFailureInformation message is sent or transmitted.

In the embodiment of this disclosure, the first timer is stopped when an RRCRelease message or an RRCReconfiguration message with reconfigurationwithSync of a PCell or an MobilityFromNRCommand message is received or an RRC connection reestablishment procedure is initiated.

In the embodiment of this disclosure, that the second timer expires includes that,
in a case where the RRCReconfiguration message is not received from another RAT,
a second timer of an MCG expires and no DAPS bearer or dual protocol stack backhaul link RLC channel is configured; or, a radio link failure is detected in a source PCell; or,
a second timer of an SCG expires, NR-DC is used and MCG transmission is suspended.

In the embodiment of this disclosure, when the RRCReconfiguration message including reconfigurationWithSync or a conditional reconfiguration execution message is received, the second timer is started.

In the embodiment of this disclosure, when random access or SCG release on a corresponding special cell is successfully completed, the second timer is stopped.

In the embodiment of this disclosure, that the RRC connection reconfiguration fails includes that,
in a case where the RRCReconfiguration is received via NR and the IAB-node or IAB-MT is not EN-DC,
the IAB-node or IAB-MT uses NR SA or NE-DC or NR-DC, and the IAB-node or IAB-MT is unable to comply with a part of configurations or embedded SCG configuration included in the RRCReconfiguration message received via SRB1, or a combination of a part of MCG configurations and a part of SCG configurations, or embedded V2X sidelink configuration, or a higher layer indicates that nas-Container is invalid, and AS security has been activated and SRB2 has been established; and/or,
the IAB-node or IAB-MT uses NR SA or NR-DC, and the IAB-node or IAB-MT is unable to comply with a part of configurations included in the RRCReconfiguration message received via SRB3, and MCG transmission is suspended.

In the embodiment of this disclosure, the integrity check failure indication from the lower layer includes at least one of the following:
an integrity check failure from a physical layer, such as DCI, or a PDCCH;
an integrity check failure from an MAC sublayer, such as an SCell activation MAC CE integrity check failure;
an integrity check failure from an RLC sublayer, such as an RLC control PDU; and
an integrity check failure from a BAP sublayer, such as a BAP control PDU.

In the embodiment of this disclosure, the first node is connected as an IAB-node, or the first node is an IAB-node.

In the embodiment of this disclosure, the first timer is timer T316, and/or, the second timer is timer T304.

In the embodiment of this disclosure, the backhaul link radio link failure notification is a type-2 radio link failure notification.

In the embodiment of this disclosure, when the second condition is satisfied, and when a fourth timer expires or is not configured, the twelfth triggering unit triggers or generates or transmits a backhaul link radio link failure notification, or when a fourth timer is running or stops, the twelfth triggering unit does not trigger or generate or transmit a backhaul link radio link failure notification.

In the embodiment of this disclosure, when a backhaul link radio link failure notification is triggered or generated or transmitted, the fourth timer is started or restarted.

In the embodiment of this disclosure, based on the state of the fourth timer, an RRC layer or BAP layer of the first node triggers or does not trigger generation of a backhaul link radio link failure notification.

In the embodiment of this disclosure, the fourth timer is stopped when at least one of the following conditions is satisfied:
receiving at least one of an RRCSetup message, an RRCRelease message and a reconfigurationWithSync message;
initiating an RRC connection reestablishment procedure;
going to an RRC-IDLE state;
the reconfiguration WithSync message is included in an spCellConfiguration message of the MAC or SCG, and the MAC of the NR cell group has successfully completed an RA procedure;
release of the second cell group or MR-DC release; and
reconfiguring the fourth timer.

In the embodiment of this disclosure, a fourth timer is configured per IAB-node, or per IAB-MT, or per cell group, or per use case.

In the embodiment of this disclosure, the fourth timer is a prohibit timer or a hysteresis timer.

It can be seen from the above embodiment that by limiting triggering the generation of a backhaul link radio link failure notifications, RLF indication storms may be avoided, resource overhead may be lowered and security risks may be reduced.

### Embodiment 6

The embodiment of this disclosure provides a network device, including the apparatus for triggering to generate a backhaul link radio link failure notification as described in embodiment 4.

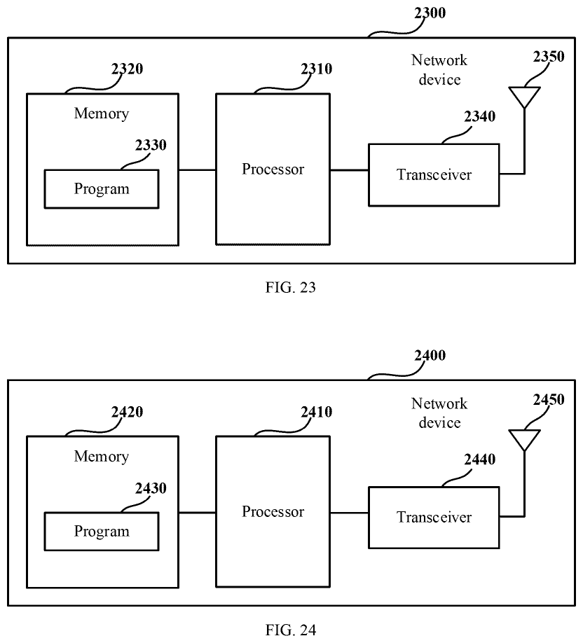

FIG. 23 is a block diagram of a systematic structure of the network device of embodiment 6 of this disclosure. As shown in FIG. 23, a network device 2300 may include a processor 2310 and a memory 2320, the memory 2320 being coupled to the processor 2310. Wherein, the memory 2320 may store various data, and furthermore, it may store a program 2330 for information processing, and execute the program 2330 under control of the processor 2310, so as to receive various information transmitted by a terminal equipment, and transmit various information to the terminal equipment.

In one implementation, functions of the apparatus for triggering to generate a backhaul link radio link failure notification may be integrated into the processor 2310.

For example, the processor 2310 may be configured to: when a radio link failure is detected and when a first condition is satisfied and/or based on a state of a timer, trigger or not to trigger to generate a backhaul link radio link failure notification; or, trigger or not to trigger to generate a backhaul link radio link failure notification based on a state of a timer; or, when a first condition is satisfied, trigger or not to trigger to generate a backhaul link radio link failure notification based on a state of a timer.

In another implementation, the apparatus for triggering to generate a backhaul link radio link failure notification and the processor 2310 may be configured separately; for example, the apparatus for triggering to generate a backhaul link radio link failure notification may be configured as a chip connected to the processor 2310, and the functions of the apparatus for triggering to generate a backhaul link radio link failure notification are executed under control of the processor 2310.

Furthermore, as shown in FIG. 23, the network device 2300 may include a transceiver 2340, and an antenna 2350, etc. Wherein, functions of the above components are similar to those in the prior art, and shall not be described herein any further. It should be noted that the network device 2300 does not necessarily include all the parts shown in FIG. 23. Furthermore, the network device 2300 may include parts not shown in FIG. 23, and the prior art may be referred to.

It can be seen from the above embodiment that by limiting triggering the generation of a backhaul link radio link failure notifications, RLF indication storms may be avoided, resource overhead may be lowered and security risks may be reduced.

### Embodiment 7

The embodiment of this disclosure provides a network device, including the apparatus for triggering to generate a backhaul link radio link failure notification as described in embodiment 5.

FIG. 24 is a block diagram of a systematic structure of the network device of embodiment 7 of this disclosure. As shown in FIG. 24, a network device 2400 may include a processor 2410 and a memory 2420, the memory 2420 being coupled to the processor 2410. Wherein, the memory 2420 may store various data, and furthermore, it may store a program 2430 for information processing, and execute the program 2430 under control of the processor 2410, so as to receive various information transmitted by a terminal equipment, and transmit various information to the terminal equipment.

In one implementation, functions of the apparatus for triggering to generate a backhaul link radio link failure notification may be integrated into the processor 2410.

For example, the processor 2410 may be configured to: trigger generation of a backhaul link radio link failure notification when a second condition is satisfied, or, when a second condition is satisfied, based on a state of a timer, trigger or not to trigger generation of a backhaul link radio link failure notification, the second condition including at least one of the following that: a first timer expires; a second timer expires; RRC connection reconfiguration fails; and an integrity check failure indication from a lower layer is received.

In another implementation, the apparatus for triggering to generate a backhaul link radio link failure notification and the processor 2410 may be configured separately; for example, the apparatus for triggering to generate a backhaul link radio link failure notification may be configured as a chip connected to the processor 2410, and the functions of the apparatus for triggering to generate a backhaul link radio link failure notification are executed under control of the processor 2410.

Furthermore, as shown in FIG. 24, the network device 2400 may include a transceiver 2440, and an antenna 2450, etc. Wherein, functions of the above components are similar to those in the prior art, and shall not be described herein any further. It should be noted that the network device 2400 does not necessarily include all the parts shown in FIG. 24. Furthermore, the network device 2400 may include parts not shown in FIG. 24, and the prior art may be referred to.

It can be seen from the above embodiment that by limiting triggering the generation of a backhaul link radio link failure notifications, RLF indication storms may be avoided, resource overhead may be lowered and security risks may be reduced.

### Embodiment 8

The embodiment of this disclosure provides a communication system, including the network device described in embodiment 6 or the network device described in embodiment 7.

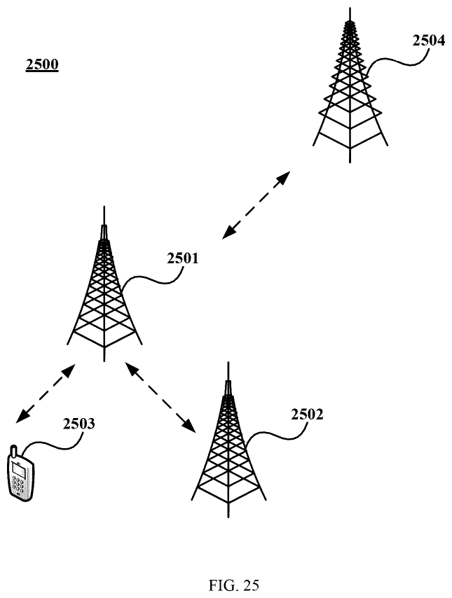

FIG. 25 is a schematic diagram of the communication system of embodiment 8 of this disclosure. As shown in FIG. 25, a communication system 2500 includes a first IAB-node 2501, a descendant IAB-node 2502 of the first IAB-node, a terminal equipment 2503 served by the first IAB-node, and a parent IAB-node 2504 of the first IAB-node, i.e. an IAB-donor-node.

For example, the first IAB-node 2501 may be the network device described in embodiment 6 or the network device described in embodiment 7.

For example, the first IAB-node 2501 detects a radio link failure of a backhaul link between it and the parent IAB-node 2504, i.e. the IAB-donor-node.

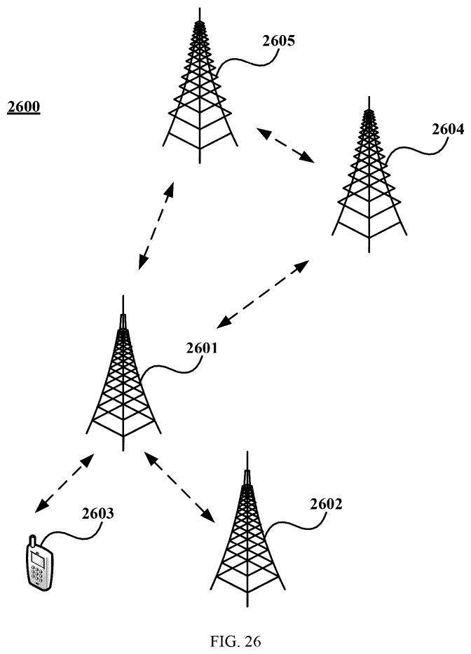

FIG. 26 is another schematic diagram of the communication system of embodiment 8 of this disclosure. As shown in FIG. 26, a communication system 2600 uses an EN-DC architecture and includes a first IAB-node 2601, a descendant IAB-node 2602 of the first IAB-node, a terminal equipment 2603 served by the first IAB-node, an IAB-donor-node 2604 and an MeNB 2605. The first IAB-node 2601 may be accessed to a network via the IAB-donor-node 2604 and the MeNB 2605.

For example, the first IAB-node 2601 may be the network device described in embodiment 6 or the network device described in embodiment 7.

For example, the first IAB-node 2601 detects an MCG RLF between it and the MeNB 2605.

For another example, the first IAB-node 2601 detects an SCG RLF between it and the IAB-donor-node 2604.

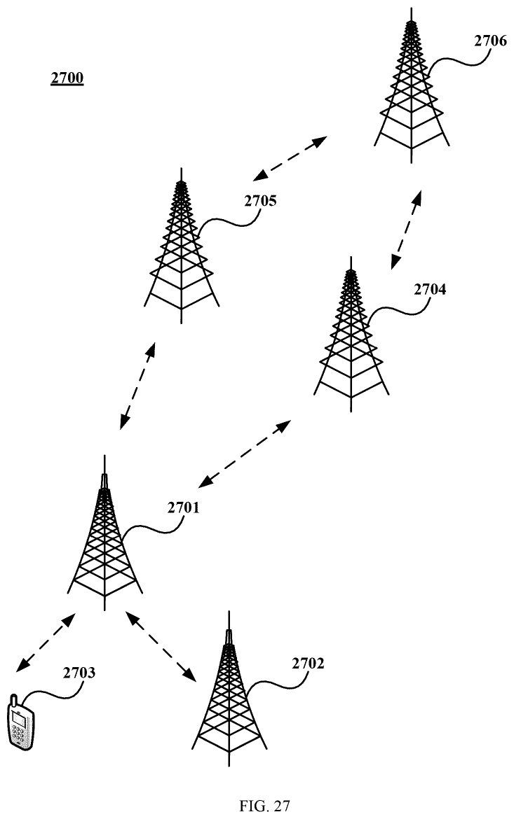

FIG. 27 is a further schematic diagram of the communication system of embodiment 8 of this disclosure. As shown in FIG. 27, a communication system 2700 uses an NR-DC architecture and includes a first IAB-node 2701, a descendant IAB-node 2702 of the first IAB-node, a terminal equipment 2703 served by the first IAB-node, a first parent IAB-node 2704 and a second parent IAB-node 2705 of the first IAB-node, and an IAB-donor-node 2706. The first IAB-node 2701 may be accessed to a network via the first parent IAB-node 2704 and the second parent IAB-node 2705. The first parent IAB-node 2704 is a master node, and the second parent IAB-node 2705 is a secondary node.

For example, the first IAB-node 2701 may be the network device described in embodiment 6 or the network device described in embodiment 7.

For example, the first IAB-node 2701 detects an MCG RLF between it and the first parent IAB-node 2704.

For another example, the first IAB-node 2701 detects an SCG RLF between it and the second parent IAB-node 2705.

What described above are some examples of IAB architectures applying the methods and apparatuses for triggering to generate a backhaul link radio link failure notification, which are also applicable to structures of communication systems under other IAB architectures.

It can be seen from the above embodiment that by limiting triggering the generation of a backhaul link radio link failure notifications, RLF indication storms may be avoided, resource overhead may be lowered and security risks may be reduced.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

According to the implementations disclosed in the embodiments, following supplements are further disclosed.

### Supplement I

1. An apparatus for triggering to generate a backhaul link radio link failure notification, applicable to a first node, the apparatus including:
a first triggering unit configured to, when a radio link failure is detected and when a first condition is satisfied and/or based on a state of a timer, trigger or not to trigger to generate a backhaul link radio link failure notification; or,
a second triggering unit configured to trigger or not to trigger to generate a backhaul link radio link failure notification based on a state of a timer; or,
a third triggering unit configured to, when a first condition is satisfied, trigger or not to trigger to generate a backhaul link radio link failure notification based on a state of a timer.
2. The apparatus according to supplement 1, wherein,
the first node is connected as an IAB-node, or the first node is an IAB-node.
3. The apparatus according to supplement 2, wherein that the first node is connected as an IAB-node, or the first node is an IAB-node includes at least one of the following that:
in a connection establishment procedure, the first node is accessed to a network as an IAB-node;
in a procedure of adding and/or updating a secondary node, the first node is connected to the secondary node as an IAB-node;
the first node serves for a descendant node or a terminal equipment as an IAB-node;
at least one connected IAB-node is taken as a descendant node of the first node; and
at least one connected IAB-node has established a backhaul link RLC channel with the first node.
4. The apparatus according to any one of supplements 1-3, wherein,
the first condition includes that AS security has been activated and SRB2 has been established.
5. The apparatus according to supplement 4, wherein the first condition further includes at least one of the following that:
in a case where the first node is configured with and/or uses dual connectivity and the radio link failure is an SCG radio link failure, an SCG failure information procedure is not initiated or is unable to be initiated;
in a case where the first node is configured with and/or uses dual connectivity and the radio link failure is an MCG radio link failure, a MCG failure information procedure is not initiated or is unable to be initiated; and
the first node is performing handover or migration.
6. The apparatus according to supplement 5, wherein that an SCG failure information procedure is not initiated or is unable to be initiated includes at least one of the following that:
the SCG failure information is unable to be reported to an IAB-donor of the first node via an F1 interface message;
the dual connectivity is NR-DC; and
MCG transmission is suspended, or an MCG failure information procedure is initiated.
7. The apparatus according to supplement 5, wherein that an MCG failure information procedure is not initiated or is unable to be initiated includes at least one of the following that:
the MCG failure information is unable to be reported to an IAB-donor of the first node via an F1 interface message;
a first timer is not configured;
SCG transmission is suspended; and
PSCell change or PSCell increase is being performed.
8. The apparatus according to supplement 5, wherein that the first node is performing handover or migration includes that:
in a case where a second timer is running, when two protocol stacks are used to connect with a source parent node and a target parent node respectively, the two protocol stacks belong to one

MT logical entity of the first node.
9. The apparatus according to supplement 5, wherein that the first node is performing handover or migration includes that:
in a case where a second timer is running, when two protocol stacks are used to connect with a source parent node and a target parent node respectively, the two protocol stacks respectively belong to two MT logical entities of the first node.
10. The apparatus according to supplement 8, wherein,
the two protocol stacks correspond to backhaul link RLC channels.
11. The apparatus according to supplement 10, wherein,
that two protocol stacks are used to connect with a source parent node and a target parent node respectively means that any dual protocol stack backhaul link RLC channel is configured.
12. The apparatus according to supplement 11, wherein,
a first domain in IE BH-RLC-ChannelConfig is used to indicate that a BH RLC channel between the first node and its parent node is configured as a dual protocol stack BH RLC channel.
13. The apparatus according to supplement 8 or 9, wherein,
the two protocol stacks correspond to RRC bearers.
14. The apparatus according to supplement 13, wherein,
that the two protocol stacks are used to connect with a source parent node and a target parent node respectively means that any dual protocol stack bearer is configured.
15. The apparatus according to supplement 14, wherein,
a second domain in IE DRB-ToAddMod is used to indicate that a bearer is configured as a dual protocol stack bearer.
16. The apparatus according to supplement 8 or 9, wherein,
when the radio link failure is a source radio link failure, generation of the backhaul link radio link failure notification is not triggered.
17. The apparatus according to supplement 8 or 9, wherein,
when the radio link failure is a source radio link failure, generation of the backhaul link radio link failure notification is triggered.
17a. The apparatus according to supplement 17, wherein,
when no radio link failure is detected in the source PCell and the second timer of the MCG expires, generation of a type-3 radio link failure notification is triggered in a protocol stack connected to the source parent node.
17b. The apparatus according to supplement 17, wherein,
when a radio link failure is successfully recovered or when the handover or migration of the first node is completed successfully, generation of a type-3 radio link failure notification is triggered in a protocol stack connected to a target parent node.
18. The apparatus according to supplement 17 or 17a or 17b, wherein,
the type-3 radio link failure notification indicates that the backhaul link has successfully recovered from the radio link failure,
and the type-3 radio link failure notification is carried by the BAP control PDU.
19. The apparatus according to supplement 17 or 17a or 17b or 18, wherein that the handover or migration of the first node is completed successfully includes at least one of the following:
the first node is synchronized to a target cell;
the first node successfully completes random access in the target cell;
the first node transmits an RRCReconfigurationComplete message;
the first node receives an explicit indication of L1 or L2, the indication being used to indicate that a source cell portion operated by the dual protocol stack is to be stopped and/or a source cell portion configured by the dual protocol stack is to be released; and
the first node has already released the source cell, as explicitly requested by the target node.
20. The apparatus according to supplement 8 or 9, wherein,
when the radio link failure is a target radio link failure,
when the target radio link failure is detected and the first condition is satisfied and/or based on the timer state, the generation of the backhaul link radio link failure notification is triggered or not triggered; or,
based on the state of the timer, the generation of the backhaul link radio link failure notification is triggered or not triggered; or,
when the first condition is satisfied, based on the state of the timer, the generation of the backhaul link radio link failure notification is triggered or not triggered.
21. The apparatus according to any one of supplements 1-20, wherein the first triggering unit includes:
a fourth triggering unit configured to trigger or generate or transmit a backhaul link radio link failure notification when a radio link failure is detected and the first condition is satisfied; or,
a fifth triggering unit configured to, when a radio link failure is detected and when a third timer expires or is not configured, trigger or generate or transmit a backhaul link radio link failure notification, or when a third timer is running or stops, not to trigger or generate or transmit a backhaul link radio link failure notification; or,
a sixth triggering unit configured to, when a radio link failure is detected and the first condition is satisfied and when a third timer expires or is not configured, trigger or generate or transmit a backhaul link radio link failure notification, or when a third timer is running or stops, not to trigger or generate or transmit a backhaul link radio link failure notification.
22. The apparatus according to any one of supplements 1-20, wherein the second triggering unit includes:
a seventh triggering unit configured to trigger or generate or transmit a backhaul link radio link failure notification when the third timer expires, or,
an eighth triggering unit configured not to trigger or generate or transmit a backhaul link radio link failure notification when the third timer is running or stops.
23. The apparatus according to supplement 22, wherein,
when a type-3 backhaul link radio link failure notification is triggered or generated or transmitted, or when a detected radio link failure is recovered, the third timer is stopped.
24. The apparatus according to any one of supplements 1-20, wherein the third triggering unit includes:
a ninth triggering unit configured to, when the first condition is satisfied and when the third timer expires, trigger or generate or transmit a backhaul link radio link failure notification, or,
a tenth triggering unit configured not to trigger or generate or transmit a backhaul link radio link failure notification when the first condition is satisfied and when the third timer is running or stops.
25. The apparatus according to supplement 24, wherein,
when a type-3 backhaul link radio link failure notification is triggered or generated or transmitted, or when a detected radio link failure is recovered, the third timer is stopped.
26. The apparatus according to any one of supplements 21-25, wherein,
when a backhaul link radio link failure notification is triggered or generated or transmitted, the third timer is started or restarted.
27. The apparatus according to any one of supplements 21-26, wherein,
an RRC layer or a BAP layer of the first node triggers or does not trigger to generate a backhaul link radio link failure notification based on a state of the third timer.
28. The apparatus according to supplement 21, wherein,
the third timer is stopped when at least one of the following conditions is satisfied: receiving at least one of an RRCSetup message, an RRCRelease message and a reconfiguration WithSync message;
initiating an RRC connection reestablishment procedure;
going to an RRC-IDLE state;
the reconfigurationWithSync message is included in an spCellConfiguration message of the MAC or SCG, and the MAC of the NR cell group has successfully completed an RA procedure;
release of the second cell group or MR-DC release; and
reconfiguring the third timer.
29. The apparatus according to any one of supplements 21-28, wherein,
a third timer is configured/operated/maintained per IAB-node or per IAB-MT or per cell group (CG) or per use case.
30. The apparatus according to any one of supplements 21-29, wherein,
the third timer is a prohibit timer or a hysteresis timer.
31. The apparatus according to any one of supplements 1-30, wherein,
the backhaul link radio link failure notification is a type-2 or type-1 radio link failure notification.
32. The apparatus according to supplement 31, wherein,
the type-2 radio link failure notification is used to indicate that the first node detects that a backhaul link radio link fails and the first node is attempting to recover from the backhaul link radio link failure,
the type-1 radio link failure notification is used to indicate that the first node detects that a backhaul link radio link fails,
and the type-2 or type-1 radio link failure notification is carried by a BAP control PDU.
33. The apparatus according to supplement 7, wherein,
the first timer is timer T316.
34. The apparatus according to supplement 8 or 9, wherein,
the second timer is timer T304.
35. An apparatus for triggering to generate a backhaul link radio link failure notification, applicable to a first node, the apparatus including:
an eleventh triggering unit configured to trigger generation of a backhaul link radio link failure notification when a second condition is satisfied, or,
a twelfth triggering unit configured to, when a second condition is satisfied, based on a state of a timer, trigger or not to trigger generation of a backhaul link radio link failure notification,
the second condition including at least one of the following that:
a first timer expires;
a second timer expires;
RRC connection reconfiguration fails; and
an integrity check failure indication from a lower layer is received.
36. The apparatus according to supplement 35, wherein,
a network configures a value of the first timer only when an IAB-node or IAB-MT is configured with split SRB1 or SRB3.
37. The apparatus according to supplement 35, wherein,
the first timer is started when an MCGFailureInformation message is sent or transmitted.
38. The apparatus according to supplement 35, wherein,
the first timer is stopped when an RRCRelease message or an RRCReconfiguration message with reconfigurationwithSync of a PCell or an MobilityFromNRCommand message is received or an RRC connection reestablishment procedure is initiated.
39. The apparatus according to supplement 35, wherein that the second timer expires includes that,
in a case where the RRCReconfiguration message is not received from another RAT,
a second timer of an MCG expires and no DAPS bearer or dual protocol stack backhaul link

RLC channel is configured; or, a radio link failure is detected in a source PCell; or,
a second timer of an SCG expires, NR-DC is used and MCG transmission is suspended.
40. The apparatus according to supplement 35, wherein,
when the RRCReconfiguration message including reconfigurationWithSync or a conditional reconfiguration execution message is received, the second timer is started.
41. The apparatus according to supplement 35, wherein,
when random access or SCG release on a corresponding special cell is successfully completed, the second timer is stopped.
42. The apparatus according to supplement 35, wherein,
that the RRC connection reconfiguration fails includes that,
in a case where the RRCReconfiguration is received via NR and the IAB-node or IAB-MT is not EN-DC,
the IAB-node or IAB-MT uses NR SA or NE-DC or NR-DC, and the IAB-node or IAB-MT is unable to comply with a part of configurations or embedded SCG configuration included in the RRCReconfiguration message received via SRB1, or a combination of a part of MCG configurations and a part of SCG configurations, or embedded V2X sidelink configuration, or a higher layer indicates that nas-Container is invalid, and AS security has been activated and SRB2 has been established; and/or,
the IAB-node or IAB-MT uses NR SA or NR-DC, and the IAB-node or IAB-MT is unable to comply with a part of configurations included in the RRCReconfiguration message received via SRB3, and MCG transmission is suspended.
43. The apparatus according to supplement 35, wherein,
the integrity check failure indication from the lower layer includes at least one of the following:
an integrity check failure from a physical layer, such as DCI, or a PDCCH;
an integrity check failure from an MAC sublayer, such as an SCell activation MAC CE integrity check failure;
an integrity check failure from an RLC sublayer, such as an RLC control PDU; and
an integrity check failure from a BAP sublayer, such as a BAP control PDU.
44. The apparatus according to supplement 35, wherein,
the first node is connected as an IAB-node, or the first node is an IAB-node.
45. The apparatus according to supplement 35, wherein,
the first timer is timer T316, and/or,
the second timer is timer T304.
46. The apparatus according to supplement 35, wherein,
the backhaul link radio link failure notification is a type-2 radio link failure notification.
47. The apparatus according to any one of supplements 35-46, wherein,
when the second condition is satisfied, and when a fourth timer expires or is not configured, the twelfth triggering unit triggers or generates or transmits a backhaul link radio link failure notification, or when a fourth timer is running or stops, the twelfth triggering unit does not trigger or generate or transmit a backhaul link radio link failure notification.
48. The apparatus according to supplement 46, wherein,
when a backhaul link radio link failure notification is triggered or generated or transmitted, the fourth timer is started or restarted.
49. The apparatus according to any one of supplements 46-48, wherein,
based on the state of the fourth timer, an RRC layer or BAP layer of the first node triggers or does not trigger generation of a backhaul link radio link failure notification.
50. The apparatus according to supplement 46, wherein,
the fourth timer is stopped when at least one of the following conditions is satisfied:
receiving at least one of an RRCSetup message, an RRCRelease message and a reconfiguration WithSync message;
initiating an RRC connection reestablishment procedure;
going to an RRC-IDLE state;
the reconfiguration WithSync message is included in an spCellConfiguration message of the MAC or SCG, and the MAC of the NR cell group has successfully completed an RA procedure;
release of the second cell group or MR-DC release; and
reconfiguring the fourth timer.
51. The apparatus according to any one of supplements 46-50, wherein,
a fourth timer is configured per IAB-node, or per IAB-MT, or per cell group, or per use case.
52. The apparatus according to any one of supplements 46-51, wherein,
the fourth timer is a prohibit timer or a hysteresis timer.
53. A network device, the network device being a first node and including the apparatus as described in any one of supplements 1-52.
54. A communication system, including the network device as described in supplement 53.

### Supplement II

1. A method for triggering to generate a backhaul link radio link failure notification, applicable to a first node, the method including:
when a radio link failure is detected and when a first condition is satisfied and/or based on a state of a timer, triggering or not triggering to generate a backhaul link radio link failure notification; or,
triggering or not triggering to generate a backhaul link radio link failure notification based on a state of a timer; or,
when a first condition is satisfied, triggering or not triggering to generate a backhaul link radio link failure notification based on a state of a timer.
2. The method according to supplement 1, wherein,
the first node is connected as an IAB-node, or the first node is an IAB-node.
3. The method according to supplement 2, wherein that the first node is connected as an IAB-node, or the first node is an IAB-node includes at least one of the following that:
in a connection establishment procedure, the first node is accessed to a network as an IAB-node;
in a procedure of adding and/or updating a secondary node, the first node is connected to the secondary node as an IAB-node;
the first node serves for a descendant node or a terminal equipment as an IAB-node;
at least one connected IAB-node is taken as a descendant node of the first node; and
at least one connected IAB-node has established a backhaul link RLC channel with the first node.
4. The method according to any one of supplements 1-3, wherein,
the first condition includes that AS security has been activated and SRB2 has been established.
5. The method according to supplement 4, wherein the first condition further includes at least one of the following that:
in a case where the first node is configured with and/or uses dual connectivity and the radio link failure is an SCG radio link failure, an SCG failure information procedure is not initiated or is unable to be initiated;
in a case where the first node is configured with and/or uses dual connectivity and the radio link failure is an MCG radio link failure, a MCG failure information procedure is not initiated or is unable to be initiated; and
the first node is performing handover or migration.
6. The method according to supplement 5, wherein that an SCG failure information procedure is not initiated or is unable to be initiated includes at least one of the following that:
the SCG failure information is unable to be reported to an IAB-donor of the first node via an F1 interface message;
the dual connectivity is NR-DC; and
MCG transmission is suspended, or an MCG failure information procedure is initiated.
7. The method according to supplement 5, wherein that an MCG failure information procedure is not initiated or is unable to be initiated includes at least one of the following that:
the MCG failure information is unable to be reported to an IAB-donor of the first node via an F1 interface message;
a first timer is not configured;
SCG transmission is suspended; and
PSCell change or PSCell increase is being performed.
8. The method according to supplement 5, wherein that the first node is performing handover or migration includes that:
in a case where a second timer is running, when two protocol stacks are used to connect with a source parent node and a target parent node respectively, the two protocol stacks belong to one MT logical entity of the first node.
9. The method according to supplement 5, wherein that the first node is performing handover or migration includes that:
in a case where a second timer is running, when two protocol stacks are used to connect with a source parent node and a target parent node respectively, the two protocol stacks respectively belong to two MT logical entities of the first node.
10. The method according to supplement 8, wherein,
the two protocol stacks correspond to backhaul link RLC channels.
11. The method according to supplement 10, wherein, that two protocol stacks are used to connect with a source parent node and a target parent node respectively means that any dual protocol stack backhaul link RLC channel is configured.
12. The method according to supplement 11, wherein,
a first domain in IE BH-RLC-ChannelConfig is used to indicate that a BH RLC channel between the first node and its parent node is configured as a dual protocol stack BH RLC channel.
13. The method according to supplement 8 or 9, wherein,
the two protocol stacks correspond to RRC bearers.
14. The method according to supplement 13, wherein,
that the two protocol stacks are used to connect with a source parent node and a target parent node respectively means that any dual protocol stack bearer is configured.
15. The method according to supplement 14, wherein,
a second domain in IE DRB-ToAddMod is used to indicate that a bearer is configured as a dual protocol stack bearer.
16. The method according to supplement 8 or 9, wherein,
when the radio link failure is a source radio link failure, generation of the backhaul link radio link failure notification is not triggered.
17. The method according to supplement 8 or 9, wherein,
when the radio link failure is a source radio link failure, generation of the backhaul link radio link failure notification is triggered.
17a. The method according to supplement 17, wherein,
when no radio link failure is detected in the source PCell and the second timer of the MCG expires, generation of a type-3 radio link failure notification is triggered in a protocol stack connected to the source parent node.
17b. The method according to supplement 17, wherein,
when a radio link failure is successfully recovered or when the handover or migration of the first node is completed successfully, generation of a type-3 radio link failure notification is triggered in a protocol stack connected to a target parent node.
18. The method according to supplement 17 or 17a or 17b, wherein,
the type-3 radio link failure notification indicates that the backhaul link has successfully recovered from the radio link failure,
and the type-3 radio link failure notification is carried by the BAP control PDU.
19. The method according to supplement 17 or 17a or 17b or 18, wherein that the handover or migration of the first node is completed successfully includes at least one of the following:
the first node is synchronized to a target cell;
the first node successfully completes random access in the target cell;
the first node transmits an RRCReconfigurationComplete message;
the first node receives an explicit indication of L1 or L2, the indication being used to indicate that a source cell portion operated by the dual protocol stack is to be stopped and/or a source cell portion configured by the dual protocol stack is to be released; and
the first node has already released the source cell, as explicitly requested by the target node.
20. The method according to supplement 8 or 9, wherein,
when the radio link failure is a target radio link failure,
when the target radio link failure is detected and the first condition is satisfied and/or based on the timer state, the generation of the backhaul link radio link failure notification is triggered or not triggered; or,
based on the state of the timer, the generation of the backhaul link radio link failure notification is triggered or not triggered; or,
when the first condition is satisfied, based on the state of the timer, the generation of the backhaul link radio link failure notification is triggered or not triggered.
21. The method according to any one of supplements 1-20, wherein the when a radio link failure is detected and when a first condition is satisfied and/or based on a state of a timer, triggering or not triggering to generate a backhaul link radio link failure notification, includes:
triggering or generating or transmitting a backhaul link radio link failure notification when a radio link failure is detected and the first condition is satisfied; or,
when a radio link failure is detected and when a third timer expires or is not configured, triggering or generating or transmitting a backhaul link radio link failure notification, or when a third timer is running or stops, not triggering or generating or transmitting a backhaul link radio link failure notification; or,
when a radio link failure is detected and the first condition is satisfied and when a third timer expires or is not configured, triggering or generating or transmitting a backhaul link radio link failure notification, or when a third timer is running or stops, not triggering or generating or transmitting a backhaul link radio link failure notification.
22. The method according to any one of supplements 1-20, wherein the triggering or not triggering to generate a backhaul link radio link failure notification based on a state of a timer includes:
triggering or generating or transmitting a backhaul link radio link failure notification when the third timer expires, or,
not triggering or generating or transmitting a backhaul link radio link failure notification when the third timer is running or stops.
23. The method according to supplement 22, wherein,
when a type-3 backhaul link radio link failure notification is triggered or generated or transmitted, or when a detected radio link failure is recovered, the third timer is stopped.
24. The method according to any one of supplements 1-20, wherein the triggering or not triggering to generate a backhaul link radio link failure notification based on a state of a timer includes:
when the first condition is satisfied and when the third timer expires, triggering or generating or transmitting a backhaul link radio link failure notification, or,
not triggering or generating or transmitting a backhaul link radio link failure notification when the first condition is satisfied and when the third timer is running or stops.
25. The method according to supplement 24, wherein,
when a type-3 backhaul link radio link failure notification is triggered or generated or transmitted, or when a detected radio link failure is recovered, the third timer is stopped.
26. The method according to any one of supplements 21-25, wherein,
when a backhaul link radio link failure notification is triggered or generated or transmitted, the third timer is started or restarted.
27. The method according to any one of supplements 21-26, wherein,
an RRC layer or a BAP layer of the first node triggers or does not trigger to generate a backhaul link radio link failure notification based on a state of the third timer.
28. The method according to supplement 21, wherein,
the third timer is stopped when at least one of the following conditions is satisfied:
receiving at least one of an RRCSetup message, an RRCRelease message and a reconfigurationWithSync message;
initiating an RRC connection reestablishment procedure;
going to an RRC-IDLE state;
the reconfigurationWithSync message is included in an spCellConfiguration message of the MAC or SCG, and the MAC of the NR cell group has successfully completed an RA procedure;
release of the second cell group or MR-DC release; and
reconfiguring the third timer.
29. The method according to any one of supplements 21-28, wherein,
a third timer is configured/operated/maintained per IAB-node or per IAB-MT or per cell group (CG) or per use case.
30. The method according to any one of supplements 21-29, wherein,
the third timer is a prohibit timer or a hysteresis timer.
31. The method according to any one of supplements 1-30, wherein,
the backhaul link radio link failure notification is a type-2 or type-1 radio link failure notification.
32. The method according to supplement 31, wherein,
the type-2 radio link failure notification is used to indicate that the first node detects that a backhaul link radio link fails and the first node is attempting to recover from the backhaul link radio link failure,
the type-1 radio link failure notification is used to indicate that the first node detects that a backhaul link radio link fails,
and the type-2 or type-1 radio link failure notification is carried by a BAP control PDU.
33. The method according to supplement 7, wherein,
the first timer is timer T316.
34. The method according to supplement 8 or 9, wherein,
the second timer is timer T304.
35. A method for triggering to generate a backhaul link radio link failure notification, applicable to a first node, the method including:
triggering generation of a backhaul link radio link failure notification when a second condition is satisfied, or,
when a second condition is satisfied, based on a state of a timer, triggering or not triggering generation of a backhaul link radio link failure notification,
the second condition including at least one of the following that:
a first timer expires;
a second timer expires;
RRC connection reconfiguration fails; and
an integrity check failure indication from a lower layer is received.
36. The method according to supplement 35, wherein,
a network configures a value of the first timer only when an IAB-node or IAB-MT is configured with split SRB1 or SRB3.
37. The method according to supplement 35, wherein,
the first timer is started when an MCGFailureInformation message is sent or transmitted.
38. The method according to supplement 35, wherein,
the first timer is stopped when an RRCRelease message or an RRCReconfiguration message with reconfigurationwithSync of a PCell or an MobilityFromNRCommand message is received or an RRC connection reestablishment procedure is initiated.
39. The method according to supplement 35, wherein that the second timer expires includes that,
in a case where the RRCReconfiguration message is not received from another RAT,
a second timer of an MCG expires and no DAPS bearer or dual protocol stack backhaul link RLC channel is configured; or, a radio link failure is detected in a source PCell; or,
a second timer of an SCG expires, NR-DC is used and MCG transmission is suspended.
40. The method according to supplement 35, wherein,
when the RRCReconfiguration message including reconfiguration WithSync or a conditional reconfiguration execution message is received, the second timer is started.
41. The method according to supplement 35, wherein,
when random access or SCG release on a corresponding special cell is successfully completed, the second timer is stopped.
42. The method according to supplement 35, wherein,
that the RRC connection reconfiguration fails includes that,
in a case where the RRCReconfiguration is received via NR and the IAB-node or IAB-MT is not EN-DC,
the IAB-node or IAB-MT uses NR SA or NE-DC or NR-DC, and the IAB-node or IAB-MT is unable to comply with a part of configurations or embedded SCG configuration included in the RRCReconfiguration message received via SRB1, or a combination of a part of MCG configurations and a part of SCG configurations, or embedded V2X sidelink configuration, or a higher layer indicates that nas-Container is invalid, and AS security has been activated and SRB2 has been established; and/or,
the IAB-node or IAB-MT uses NR SA or NR-DC, and the IAB-node or IAB-MT is unable to comply with a part of configurations included in the RRCReconfiguration message received via SRB3, and MCG transmission is suspended.
43. The method according to supplement 35, wherein,
the integrity check failure indication from the lower layer includes at least one of the following:
an integrity check failure from a physical layer, such as DCI, or a PDCCH;
an integrity check failure from an MAC sublayer, such as an SCell activation MAC CE integrity check failure;
an integrity check failure from an RLC sublayer, such as an RLC control PDU; and
an integrity check failure from a BAP sublayer, such as a BAP control PDU.
44. The method according to supplement 35, wherein,
the first node is connected as an IAB-node, or the first node is an IAB-node.
45. The method according to supplement 35, wherein,
the first timer is timer T316, and/or,
the second timer is timer T304.
46. The method according to supplement 35, wherein,
the backhaul link radio link failure notification is a type-2 radio link failure notification.
47. The method according to any one of supplements 35-46, wherein the when a second condition is satisfied, based on a state of a timer, triggering or not triggering generation of a backhaul link radio link failure notification, includes:
when the second condition is satisfied, and when a fourth timer expires or is not configured, triggering or generating or transmitting a backhaul link radio link failure notification, or when a fourth timer is running or stops, not triggering or generating or transmitting a backhaul link radio link failure notification.
48. The method according to supplement 46, wherein,
when a backhaul link radio link failure notification is triggered or generated or transmitted, the fourth timer is started or restarted.
49. The method according to any one of supplements 46-48, wherein,
based on the state of the fourth timer, an RRC layer or BAP layer of the first node triggers or does not trigger generation of a backhaul link radio link failure notification.
50. The method according to supplement 46, wherein,
the fourth timer is stopped when at least one of the following conditions is satisfied:
receiving at least one of an RRCSetup message, an RRCRelease message and a reconfiguration WithSync message;
initiating an RRC connection reestablishment procedure;
going to an RRC-IDLE state;
the reconfiguration WithSync message is included in an spCellConfiguration message of the MAC or SCG, and the MAC of the NR cell group has successfully completed an RA procedure;
release of the second cell group or MR-DC release; and
reconfiguring the fourth timer.
51. The method according to any one of supplements 46-50, wherein,
a fourth timer is configured per IAB-node, or per IAB-MT, or per cell group, or per use case.
52. The method according to any one of supplements 46-51, wherein,
the fourth timer is a prohibit timer or a hysteresis timer.

1. An apparatus for triggering to generate a backhaul link radio link failure notification, applicable to a first node, the apparatus comprising:
a memory; and
a processor coupled to the memory and configured to:
trigger, when a radio link failure is detected and when AS security has been activated and an SRB2 has been established and the first node is configured with and/or uses NR-DC, to generate the backhaul link radio link failure notification.

2. The apparatus according to claim 1, wherein,
the first node is an IAB-node.

3. The apparatus according to claim 2, wherein that the first node is an IAB-node comprises at least one of the following that:
in a connection establishment process, the first node is accessed to a network as an IAB-node;
in a process of adding and/or updating a secondary node, the first node is connected to the secondary node as an IAB-node;
the first node serves for a descendant node or a terminal equipment as an IAB-node;
at least one connected IAB-node is taken as a descendant node of the first node; and
at least one connected IAB-node has established a backhaul link RLC channel with the first node.

4. The apparatus according to claim 1, wherein
the processor is further configured to trigger or generate or transmit the backhaul link radio link failure notification when a radio link failure is detected and the AS security has been activated and an SRB2 has been established and the first node is configured with and/or uses NR-DC.

5. The apparatus according to claim 1, wherein
the processor is further configured to:
trigger or generate or transmit, when a radio link failure is detected and when a third timer expires or is not configured, the backhaul link radio link failure notification, or
control to not trigger or not generate or not transmit, when the third timer is running or stops, the backhaul link radio link failure notification.

6. The apparatus according to claim 1, wherein
the processor is further configured to trigger or generate or transmit, when a radio link failure is detected and the AS security has been activated and an SRB2 has been established and the first node is configured with and/or uses NR-DC and when a third timer expires or is not configured, the backhaul link radio link failure notification, or
control to not trigger or not generate or not transmit, when a third timer is running or stops, the backhaul link radio link failure notification.

7. The apparatus according to claim 5, wherein,
when the backhaul link radio link failure notification is triggered or generated or transmitted, the third timer is started or restarted.

8. The apparatus according to claim 5, wherein an RRC layer or a BAP layer of the first node triggers or does not trigger to generate the backhaul link radio link failure notification based on a state of the third timer.

9. The apparatus according to claim 5, wherein,
the third timer is a prohibit timer or a hysteresis timer.

10. The apparatus according to claim 1, wherein,
the backhaul link radio link failure notification is a type 2 or type 1 radio link failure notification.

11. The apparatus according to claim 10, wherein,
the type 2 radio link failure notification is used to indicate that the first node detects that a backhaul link radio link fails and the first node is attempting to recover from the backhaul link radio link failure,
the type 1 radio link failure notification is used to indicate that the first node detects that a backhaul link radio link fails,
and the type 2 or type 1 radio link failure notification is carried by a BAP control PDU.

12. The apparatus according to claim 6, wherein,
when the backhaul link radio link failure notification is triggered or generated or transmitted, the third timer is started or restarted.

13. The apparatus according to claim 6, wherein an RRC layer or a BAP layer of the first node triggers or does not trigger to generate the backhaul link radio link failure notification based on a state of the third timer.

14. The apparatus according to claim 6, wherein,
the third timer is a prohibit timer or a hysteresis timer.
